(19) United States
(12) Patent Application Publication
(10) Pub. No.: US 2017/0181139 A1
(43) Pub. Date: Jun. 22, 2017

(54) WIRELESS COMMUNICATIONS METHOD, WIRELESS COMMUNICATIONS SYSTEM, BASE STATION, AND TERMINAL

(71) Applicant: FUJITSU LIMITED, Kawasaki-shi (JP)

(72) Inventors: Michiharu Nakamura, Yokosuka (JP); YOSHIHIRO KAWASAKI, Kawasaki (JP); YOSHINORI TANAKA, Yokohama (JP)

(73) Assignee: FUJITSU LIMITED, Kawasaki-shi (JP)

(21) Appl. No.: 15/447,648

(22) Filed: Mar. 2, 2017

Related U.S. Application Data
(63) Continuation of application No. PCT/JP2014/073103, filed on Sep. 2, 2014.

(51) Int. Cl. H04W 72/04; H04W 4/06; H04W 76/02

(52) U.S. Cl. CPC H04W 72/042; H04W 76/023; H04W 4/06; H04W 92/18

(57) ABSTRACT

In a first case, a base station transmits to a first terminal, first assignment information that indicates radio resources in a first range assigned to terminal-to-terminal communication; the first terminal uses the radio resources indicated by the first assignment information and transmits a signal to a second terminal; and the second terminal receives the signal from the first terminal based on broadcast information transmitted by the base station. In a second case, the base station transmits to the first terminal, second assignment information that indicates radio resources in the first range and a second range assigned to the terminal-to-terminal communication. The first terminal uses the radio resources in the first range indicated by the second assignment information and transmits to the second terminal, control information that indicates the radio resources in the second range and transmits/receives signals to/from the second terminal by using the radio resources in the second range.

### CROSS REFERENCE TO RELATED APPLICATIONS

This application is a continuation application of International Application PCT/JP2014/073103, filed on Sep. 2, 2014, and designating the U.S., the entire contents of which are incorporated herein by reference.

### FIELD

The embodiments discussed herein relate to a wireless communications method, a wireless communications system, a base station, and a terminal.

### BACKGROUND

In a conventionally known technique of device-to-device (D2D) communication that is wireless communication performed directly between terminals, a base station assigns radio resources for D2D communication to a terminal (see, for example, US Patent Application Publication Nos. 2013/0150061 and 2013/0322413).

### SUMMARY

According to an aspect of an embodiment, a wireless communications method includes transmitting, by a base station, broadcast information broadcasting a first range of radio resources, wherein in a first case, the base station transmits to the first terminal, first assignment information that indicates radio resources in the first range assigned to terminal-to-terminal communication between a first terminal and a second terminal, the first terminal transmits a signal to the second terminal by using the radio resources indicated by the first assignment information transmitted by the base station, and the second terminal receives the signal from the first terminal based on the broadcast information transmitted by the base station. In a second case different from the first case, the base station transmits to the first terminal, second assignment information that indicates the radio resources in the first range and radio resources in a second range different from the first range and assigned to the terminal-to-terminal communication, the first terminal transmits control information that indicates the radio resources in the second range indicated by the second assignment information to the second terminal, the first terminal transmitting the control information by using the radio resources in the first range indicated by the second assignment information transmitted by the base station, and the second terminal receives the control information from the first terminal, based on the broadcast information transmitted by the base station and using the radio resources in the second range, performs at least one of reception of a signal from the first terminal and transmission of a signal to the first terminal, based on the received control information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram of an example of a wireless communications system according to an embodiment;

FIG. 2A is a diagram of an operation example 1 of the wireless communications system in a first case;

FIG. 2B is a diagram of the operation example 1 of the wireless communications system in a second case;

FIG. 3A is a diagram of an operation example 2 of the wireless communications system in the first case;

FIG. 3B is a diagram of the operation example 2 of the wireless communications system in the second case;

FIG. 4A is a diagram of an operation example 3 of the wireless communications system in the first case;

FIG. 4B is a diagram of the operation example 3 of the wireless communications system in the second case;

FIG. 5 is a diagram of an example of a radio frame;

FIG. 6A is a diagram of an example of a format of first radio resource range information transmitted by a base station;

FIG. 6B is a diagram of an example of a format of assignment information transmitted by the base station;

FIG. 6C is a diagram of an example of a signal transmitted by a first terminal to a second terminal;

FIG. 6D is a diagram of another example of the signal transmitted by the first terminal to the second terminal;

FIG. 7 is a flowchart of an example of a process by the base station;

FIG. 8 is a flowchart of an example of a process by the first terminal;

FIG. 9 is a flowchart of an example of a process by the second terminal;

FIG. 10A is a diagram of an example of a configuration of the base station;

FIG. 10B is a diagram of an example of signal flow in the configuration of the base station depicted in FIG. 10A;

FIG. 11A is a diagram of an example of a hardware configuration of the base station;

FIG. 11B is a diagram of an example of signal flow in the hardware configuration of the base station depicted in FIG. 11A;

FIG. 12A is a diagram of an example of a terminal configuration;

FIG. 12B is a diagram of an example of signal flow in the terminal configuration depicted in FIG. 12A;

FIG. 13A is a diagram of an example of a hardware configuration of the terminal; and

FIG. 13B is a diagram of an example of signal flow in the hardware configuration of the terminal depicted in FIG. 13A.

### DESCRIPTION OF THE INVENTION

Embodiments of a wireless communications method, a wireless communications system, a base station, and a terminal according to the present invention will be described in detail with reference to the accompanying drawings.

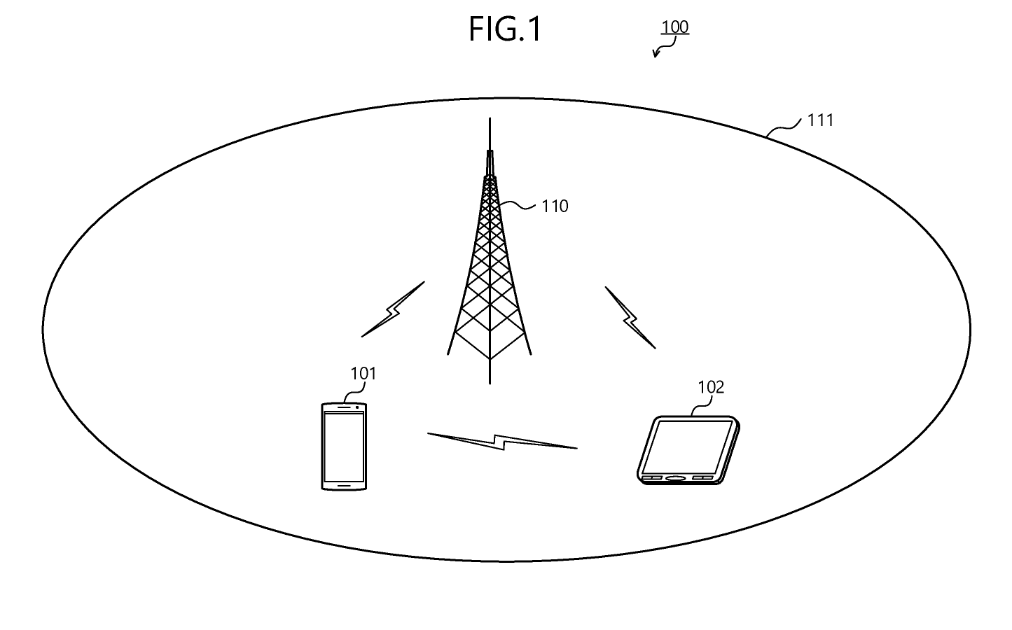

FIG. 1 is a diagram of an example of a wireless communications system according to an embodiment. As depicted in FIG. 1, a wireless communications system 100 according to an embodiment includes a base station 110, a first terminal 101, and a second terminal 102.

A cell 111 is a cell formed by the base station 110. The first terminal 101 and the second terminal 102 are located in the cell 111 and are configured to wirelessly communicate with the base station 110. The first terminal 101 and the second terminal 102 are configured to directly perform wireless terminal-to-terminal communication (D2D communication) with each other.

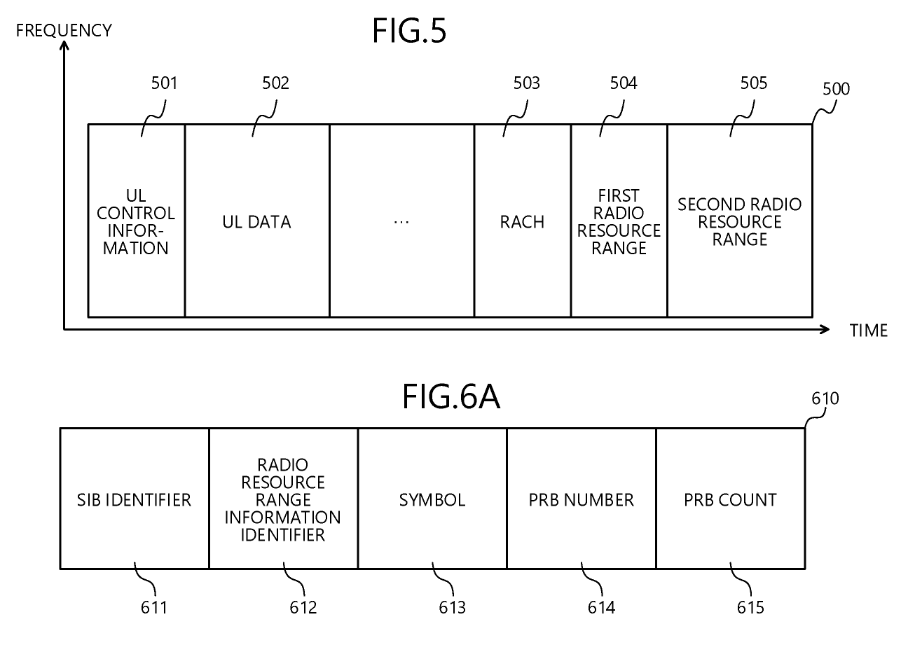

The base station 110 sets a first radio resource range and a second radio resource range as ranges of radio resources usable for the terminal-to-terminal communication between the first terminal 101 and the second terminal 102. An example of setting the first radio resource range and the second radio resource range will be described later (see, for example, FIG. 5).

In a first case, the base station 110 assigns the radio resources in the first radio resource range to the terminal-to-terminal communication between the first terminal 101 and the second terminal 102. The first case is, for example, a case where an amount of radio resources to be assigned to the terminal-to-terminal communication between the first terminal 101 and the second terminal 102 is equal to or less than a predetermined amount.

In a second case, the base station 110 assigns the radio resources in the first radio resource range and the second radio resource range to the terminal-to-terminal communication between the first terminal 101 and the second terminal 102. The second case is, for example, a case where an amount of radio resources to be assigned to the terminal-to-terminal communication between the first terminal 101 and the second terminal 102 is greater than the predetermined amount.

For example, the first terminal 101 is a smartphone having a wireless communications function. However, the first terminal 101 is not limited to a smartphone and may be any among various types of wireless communication terminals. For example, the second terminal 102 is a tablet having a wireless communications function. However, the second terminal 102 is not limited to a tablet and may be any among various types of wireless communications terminals.

In the case described in this embodiment, when terminal-to-terminal communication is performed between the first terminal 101 and the second terminal 102, the first terminal 101 makes a request to the base station 110 for radio resources for the terminal-to-terminal communication.

It is noted that the second terminal 102 may be a terminal unable to perform data communication with the base station 110, such as a terminal of an operator different from that of the base station 110. Even in this case, the second terminal 102 may intercept broadcast information transmitted from the base station 110.

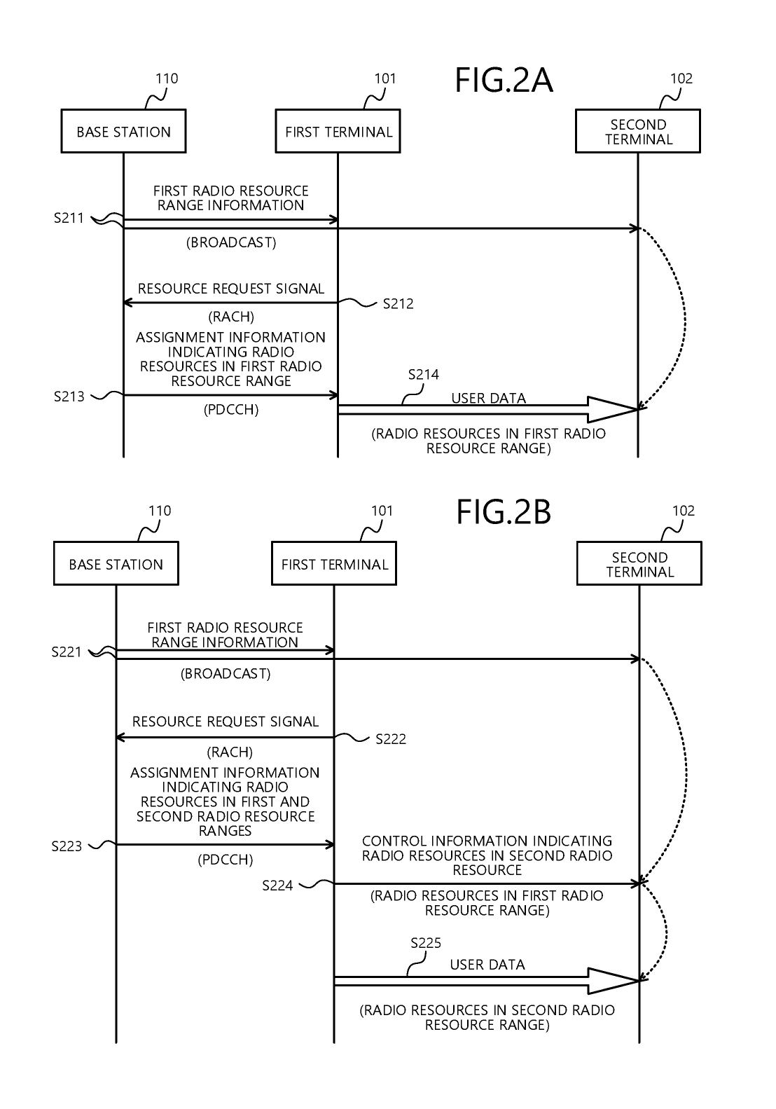

FIG. 2A is a diagram of an operation example 1 of the wireless communications system in the first case. In FIG. 2A, the operation of data transmission from the first terminal 101 to the second terminal 102 in the first case will be described. As depicted in FIG. 2A, first, the base station 110 transmits first radio resource range information that indicates the configured first radio resource range (step S211). The first terminal 101 and the second terminal 102 receive the first radio resource range information transmitted at step S211.

The first radio resource range information is broadcast information transmitted by broadcasting, for example. The first radio resource range information may be transmitted at step S211 by using the physical downlink shared channel (PDSCH), for example. Alternatively, the first radio resource range information may be transmitted at step S211 by using the physical broadcast channel (PBCH).

It is assumed that a request for execution of terminal-to-terminal communication with the second terminal 102 is generated in the first terminal 101. For example, it is assumed that the first terminal 101 and the second terminal 102 each accept an execution operation for terminal-to-terminal communication from a user.

In response, the first terminal 101 transmits to the base station 110, a resource request signal requesting radio resources for use in the terminal-to-terminal communication with the second terminal 102 (step S212). It is noted that which of the first terminal 101 and the second terminal 102 transmits the resource request signal is determined by user operation, for example.

At step S212, the first terminal 101 may transmit the resource request signal to the base station 110 by using a random access channel (RACH), for example. However, this is not a limitation of the method of transmitting the resource request signal. For example, the first terminal 101 may first request the base station 110 to assign radio resources for transmitting a UL signal and may transmit the resource request signal to the base station 110 by using the radio resources assigned from the base station 110.

The resource request signal may include information that indicates an assignment amount of radio resources requested for the terminal-to-terminal communication between the first terminal 101 and the second terminal 102. For example, the assignment amount of radio resources may be determined by user operation or may be determined by the first terminal 101 according to an amount of data to be transmitted/received through the terminal-to-terminal communication related to the generated execution request.

The resource request signal may include, for example, a buffer status report (BSR) that indicates an amount of data retained in a transmission buffer of the first terminal 101. Alternatively, after the first terminal 101 transmits the resource request signal to the base station 110, the base station 110 may request the buffer status report from the first terminal 101 and the first terminal 101 may transmit the buffer status report to the base station 110.

In response to the resource request signal from the first terminal 101, the base station 110 determines whether to assign the radio resources only in the first radio resource range or assign the radio resources in the first radio resource range and the second radio resource range. This determination is made based on the assignment amount of the radio resources required for the terminal-to-terminal communication between the first terminal 101 and the second terminal 102. The assignment amount of the radio resources required for the terminal-to-terminal communication between the first terminal 101 and the second terminal 102 may be determined from the resource request signal and the buffer status report from the first terminal 101, for example.

In the example depicted in FIG. 2A, the base station 110 is assumed to determine that the amount of radio resources to be assigned to the terminal-to-terminal communication between the first terminal 101 and the second terminal 102 is equal to or less than the predetermined amount (the first case). In this case, the base station 110 assigns the radio resources only in the first radio resource range. For example, the predetermined amount is the total amount in the first radio resource range, for example. Alternatively, the predetermined amount may be the total amount of currently usable free radio resources in the first radio resource range, for example.

The base station 110 then transmits to the first terminal 101 assignment information that indicates the assigned radio resources in the first radio resource range (step S213). This enables the first terminal 101 to recognize that the radio resources for the terminal-to-terminal communication with the second terminal 102 are assigned by the base station 110. The transmission at step S213 may be performed by using an individual control signal of a DL such as the physical downlink control channel (PDCCH), for example.

The first terminal 101 then directly transmits user data to the second terminal 102 by using the radio resources in the first radio resource range indicated by the assignment information transmitted at step S213 (step S214). The user data transmitted at step S214 may include a code identifying the second terminal 102. This enables the second terminal 102 to identify received data addressed thereto and discard received data addressed to other terminals before interpreting the received data in a process of a higher layer, for example.

The second terminal 102 receives the user data transmitted from the first terminal 101 at step S214. For example, when accepting the execution operation for the terminal-to-terminal communication from the user, the second terminal 102 performs a receiving operation in the first radio resource range based on the first radio resource range information transmitted by broadcasting at step S211. As a result, the second terminal 102 is able to receive the user data transmitted from the first terminal 101 at step S214.

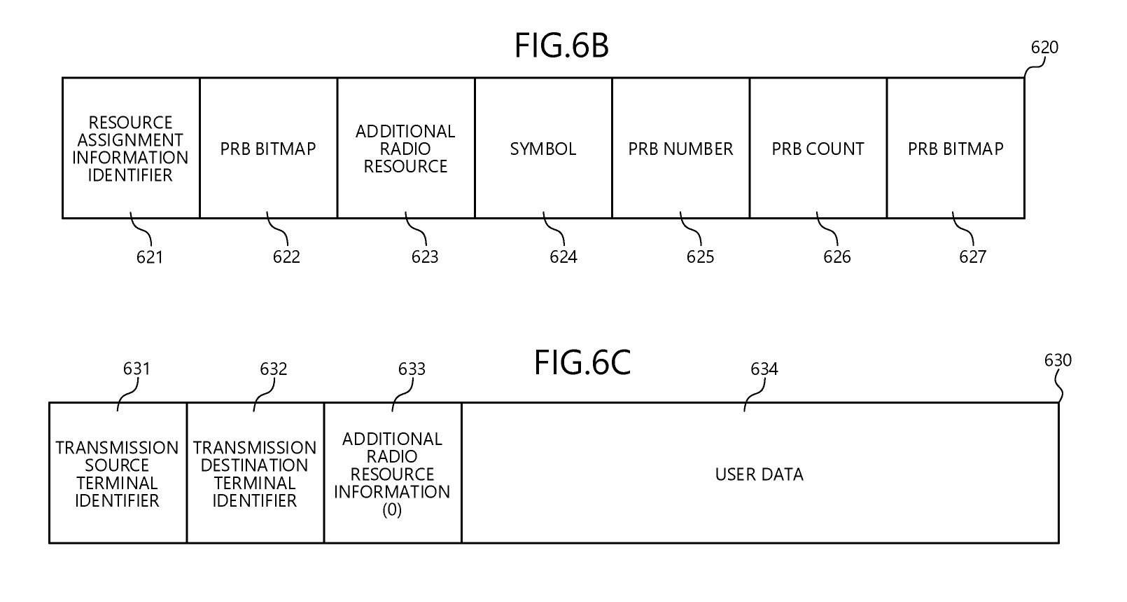

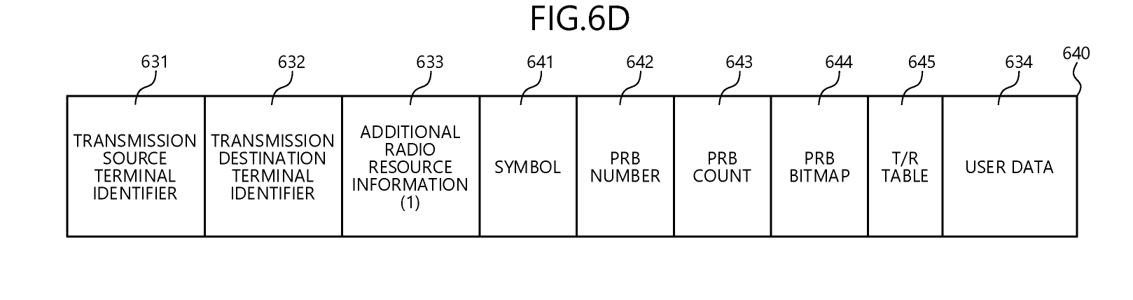

It is noted that the base station 110 may provide in the assignment information transmitted at step S213, a field representing the assignment information for notification of radio resources for terminal-to-terminal communication (see, for example, FIG. 6B). Alternatively, the first terminal 101 may use different identification codes as individual identification codes used in control signals between the control signal for notification of radio resources assigned to UL transmission from the first terminal 101 to the base station 110 and the assignment information for notification of radio resources for terminal-to-terminal communication. This enables the first terminal 101 to make a distinction between the control signal for notification of radio resources assigned to UL transmission from the first terminal 101 to the base station 110 and the assignment information for notification of radio resources for terminal-to-terminal communication.

The first terminal 101 is able to determine whether the radio resources indicated by the received assignment information are the radio resources in the first radio resource range, based on the first radio resource range information transmitted at step S211. Therefore, the assignment information may not have information added thereto that indicates whether the radio resources indicated by the assignment information are the radio resources in the first radio resource range.

FIG. 2B is a diagram of the operation example 1 of the wireless communications system in the second case. In FIG. 2B, the operation of data transmission from the first terminal 101 to the second terminal 102 in the second case will be described. Steps S221 to S223 depicted in FIG. 2B are the same as steps S211 to S213 depicted in FIG. 2A. However, in the example depicted in FIG. 2B, the base station 110 is assumed to determine that the amount of radio resources to be assigned to the terminal-to-terminal communication between the first terminal 101 and the second terminal 102 is larger than the predetermined amount (the second case).

In this case, the base station 110 assigns radio resources in the first radio resource range and the second radio resource range. At step S223, the base station 110 transmits to the first terminal 101, assignment information that indicates the assigned radio resources in the first radio resource range and the second radio resource range.

The first terminal 101 then transmits to the second terminal 102, control information that indicates the radio resources in the second radio resource range indicated by the assignment information transmitted at step S223 (step S224). The control information is transmitted at step S224 by using the radio resources in the first radio resource range indicated by the assignment information transmitted at step S223.

In response, the second terminal 102 receives the control information transmitted from the first terminal 101 at step S224. For example, the second terminal 102 is able to receive the control information transmitted from the first terminal 101, by performing a receiving operation in the first radio resource range based on the first radio resource range information transmitted by broadcasting at step S221.

The first terminal 101 then directly transmits user data to the second terminal 102 by using the radio resources in the second radio resource range indicated by the assignment information transmitted at steps S221 to S223 (step S225). The user data transmitted at step S225 may include a code identifying the second terminal 102. This enables the second terminal 102 to identify received data addressed thereto and discard received data addressed to other terminals before interpreting the received data in a process of the higher layer, for example.

The second terminal 102 receives the user data transmitted from the first terminal 101 at step S225. For example, the second terminal 102 performs a receiving operation in the second radio resource range based on the control information received from the first terminal 101 at step S224. As a result, the second terminal 102 may receive the user data transmitted from the first terminal 101 at step S225.

Although the user data is transmitted by using the radio resources in the second radio resource range at step S225 in the above description, the radio resources in the first radio resource range assigned by the base station 110 may be used together for the transmission of the user data. For example, if the assigned radio resources in the first radio resource range remain in addition to the radio resources used for transmission of the control information at step S224, the first terminal 101 may also use the remaining radio resources for transmitting the user data.

In this case, the second terminal 102 performs a receiving operation in the first radio resource range and the second radio resource range. As a result, the second terminal 102 may receive the user data transmitted from the first terminal 101 at step S225.

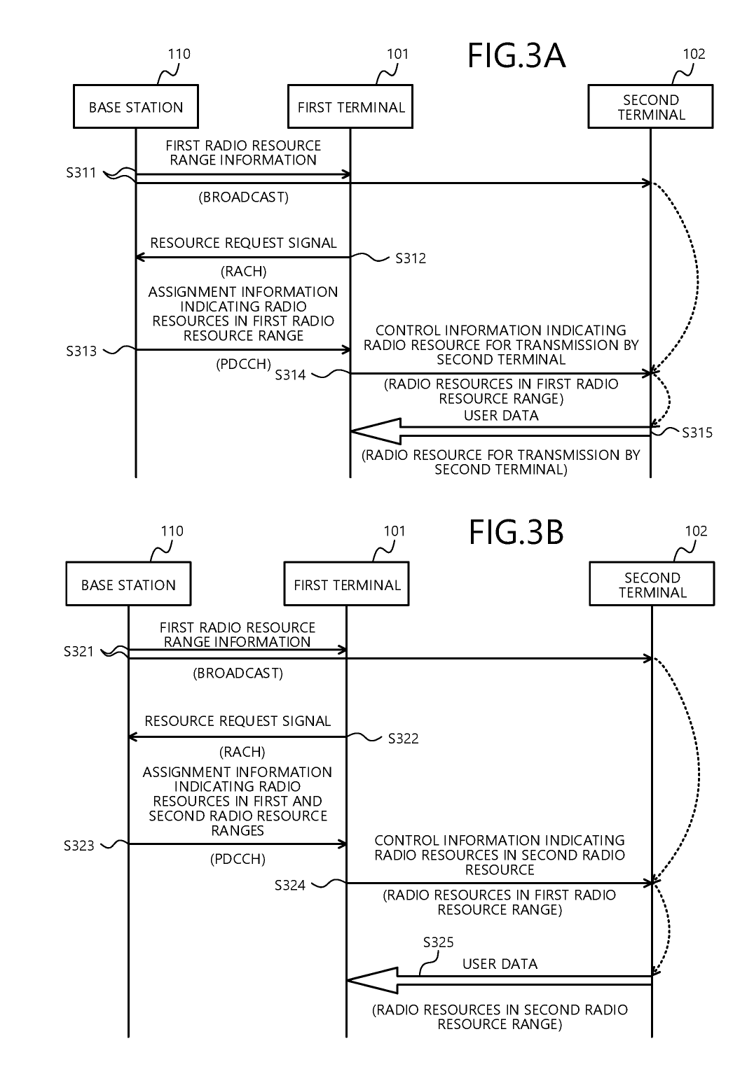

FIG. 3A is a diagram of an operation example 2 of the wireless communications system in the first case. In FIG. 3A, the operation of data transmission from the second terminal 102 to the first terminal 101 in the first case will be described. Steps S311 to S313 depicted in FIG. 3A are the same as steps S211 to S213 depicted in FIG. 2A.

After step S313, the operation goes to step S314. In particular, the first terminal 101 directly transmits to the second terminal 102, control information that indicates a radio resource for transmission by the second terminal 102 by using a first resource among the radio resources in the first radio resource range indicated by the assignment information from the base station 110 (step S314). The radio resource for transmission by the second terminal 102 is a second resource different from the first resource.

In response, the second terminal 102 performs a receiving operation in the first radio resource range based on the first radio resource range information transmitted by broadcasting at step S311. As a result, the control information transmitted from the first terminal 101 at step S314 may be received.

The radio resource for transmission by the second terminal 102 is a radio resource included among the radio resources in the first radio resource range indicated by the assignment information transmitted at step S313. The radio resource for transmission by the second terminal 102 may be determined by the first terminal 101 or may be determined by the base station 110 before the first terminal 101 is notified at step S313.

The second terminal 102 then directly transmits user data to the first terminal 101 by using the radio resource for transmission by the second terminal 102 indicated by the control information transmitted at step S314 (step S315).

FIG. 3B is a diagram of the operation example 2 of the wireless communications system in the second case. In FIG. 3B, the operation of data transmission from the second terminal 102 to the first terminal 101 in the second case will be described. Steps S321 to S324 depicted in FIG. 3B are the same as steps S221 to S224 depicted in FIG. 2B.

After step S324, the second terminal 102 directly transmits user data to the first terminal 101 by using the radio resources in the second radio resource range indicated by the control information transmitted at step S324 (step S325).

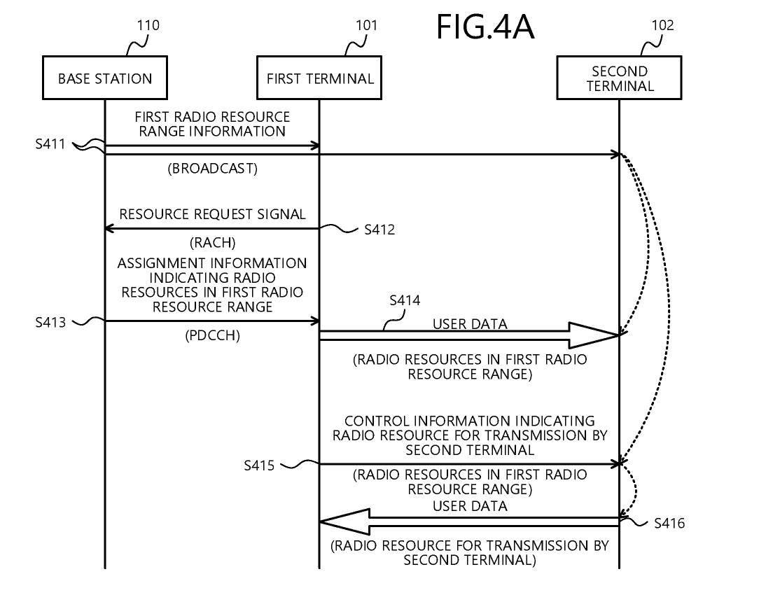

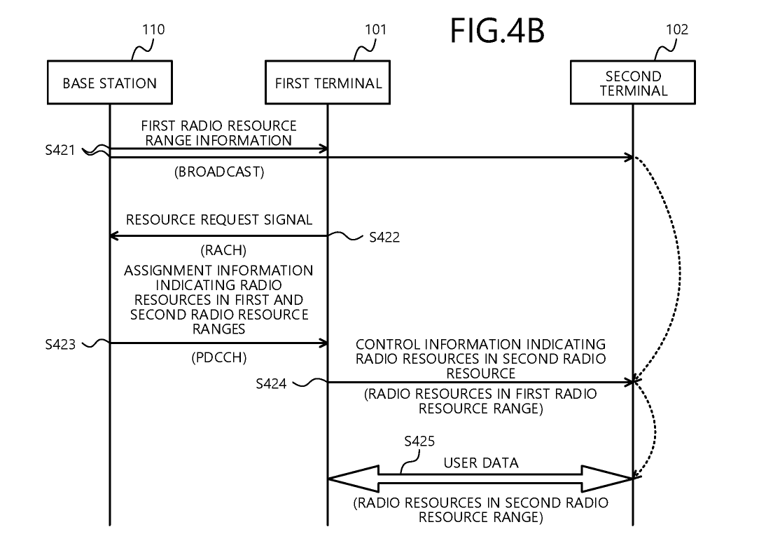

FIG. 4A is a diagram of an operation example 3 of the wireless communications system in the first case. In FIG. 4A, an operation of bidirectional data transmission between the first terminal 101 and the second terminal 102 in the first case will be described. Steps S411 to S414 depicted in FIG. 4A are the same as steps S211 to S214 depicted in FIG. 2A.

Steps S415, S416 subsequent to step S414 are the same as steps S314, S315 depicted in FIG. 3A. The data transmission from the first terminal 101 to the second terminal 102 at step S414 may be performed after the data transmission from the second terminal 102 to the first terminal 101 at steps S415, S416.

FIG. 4B is a diagram of the operation example 3 of the wireless communications system in the second case. In FIG. 4B, the operation of bidirectional data transmission between the first terminal 101 and the second terminal 102 in the second case will be described. Steps S421 to S425 depicted in FIG. 4B are the same as steps S221 to S225 depicted in FIG. 2B.

However, at step S425, the data transmission from the first terminal 101 to the second terminal 102 is performed along with the data transmission from the second terminal 102 to the first terminal 101. At step S425, the second terminal 102 directly transmits user data to the first terminal 101 by using the radio resources in the second radio resource range indicated by the control information transmitted from the first terminal 101 at step S424 (step S425).

For example, at step S424, the first terminal 101 transmits to the second terminal 102, control information that indicates the first resource and the second resource among the radio resources in the second radio resource range. At step S425, the first terminal 101 transmits the user data (signals) to the second terminal 102 by using the first resource.

In response, the second terminal 102 receives the user data (signals) from the first terminal 101 at step S425 based on the first resource indicated by the control information received at step S424. Additionally, the second terminal 102 transmits the user data (signals) to the first terminal 101 at step S425 by using the second resource indicated by the control information received at step S424.

As depicted in FIGS. 2A, 3A, and 4A, in the first case, the base station 110 transmits to the first terminal 101, first assignment information that indicates the radio resources in the first radio resource range (first range) assigned to the terminal-to-terminal communication between the first terminal 101 and the second terminal 102. The first terminal 101 transmits signals such as user data and control signals to the second terminal 102 by using the radio resources indicated by the first assignment information transmitted by the base station 110. In response, the second terminal 102 may receive the signals from the first terminal 101 based on the first radio resource range information (broadcast information) transmitted by the base station 110.

As depicted in FIGS. 2B, 3B, and 4B, in the second case, the base station 110 assigns the radio resources in the first radio resource range and the radio resources in the second radio resource range to the terminal-to-terminal communication between the first terminal 101 and the second terminal 102. The base station 110 then transmits to the first terminal 101, second assignment information that indicates the assigned radio resources. The first terminal 101 uses the radio resources in the first radio resource range indicated by the second assignment information transmitted by the base station 110 and transmits to the second terminal 102, the control information that indicates the radio resources in the second radio resource range indicated by the second assignment information. In response, the second terminal 102 is able to receive the control information from the first terminal 101 based on the broadcast information transmitted by the base station 110. Additionally, the second terminal 102 may perform at least one of reception of signals from the first terminal 101 and transmission of signals to the first terminal 101, based on the received control information by using the radio resources in the second radio resource range.

In the examples depicted in FIGS. 2A to 4B, the first case is a case where the amount of radio resources to be assigned to terminal-to-terminal communication is equal to or less than the predetermined amount, and the second case is a case where the amount of radio resources to be assigned to terminal-to-terminal communication is greater than the predetermined amount. However, the first case and the second case are not limited hereto and may be, for example, cases according to the availability of radio resources in the first radio resource range, the types of the first terminal 101 and the second terminal 102, etc.

For example, it is assumed that the first radio resource range is in the range of n symbols on the time axis and m blocks on the frequency axis. For example, n is smaller than the number N of symbols on the time axis of the entire radio frame (the radio resource range assigned to the cell 111 of the base station 110). For example, m is smaller than the number M of blocks on the frequency axis of the entire radio frame.

To notify the first terminal 101 of an assignment result of the radio resources in the entire radio frame, N×M pieces of information are stored in the assignment information. For example, assuming N=14 and M=50, 4 [bits] for indicating the position on the time axis and 6 [bits] for indicating the position on the frequency axis are required, making a total of 10 [bits].

On the other hand, if the first terminal 101 is notified of an assignment result of the radio resources in the first radio resource range that is a portion of the entire radio frame, n×m pieces of information may be stored in the assignment information. For example, the base station 110 transmits to the first terminal 101, the assignment information that indicates the assigned radio resources in the first radio resource range in terms of relative positions in the first radio resource range.

On the other hand, the first terminal 101 is able to identify the radio resources in the first radio resource range assigned by the base station 110, based on the first radio resource range indicated by the first radio resource range information from the base station 110 and the relative positions indicated by the assignment information.

For example, assuming n=2 and m=25, 1 [bit] for indicating the position on the time axis and 5 [bits] for indicating the position on the frequency axis are required, making a total of 6 [bits]. Therefore, the amount of the assignment information is reduced.

The first terminal 101 may transmit to the second terminal 102, a control signal that indicates the radio resources in the first radio resource range in terms of relative positions in the first radio resource range. On the other hand, the second terminal 102 is able to identify the radio resources in the first radio resource range based on the first radio resource range indicated by the first radio resource range information from the base station 110 and the relative positions indicated by the control signal. Therefore, the amount of information of the control signal may be reduced.

The base station 110 assigns the radio resources only in the first radio resource range in the first case and assigns the radio resources in the first radio resource range and the second radio resource range in the second case. Therefore, as compared to a configuration in which radio resources are always assigned among the radio resource range of an amount corresponding to the total of the first radio resource range and the second radio resource range, the amount of the assignment information notifying the first terminal 101 of the assignment result may be reduced.

Although the base station 110 transmits the first radio resource range information by broadcasting in the cases described with reference to FIGS. 2A to 4B, the base station 110 may transmit the second radio resource range information by broadcasting in addition to the first radio resource range information. The second radio resource range information is broadcast information that indicates the second radio resource range. Alternatively, the second radio resource range may be configured in advance as a specification in the first terminal 101 and the second terminal 102.

The second radio resource range may be a radio resource range that is identifiable by the first terminal 101 and the second terminal 102 from the first radio resource range. For example, the second radio resource range may be a range adjacent to the first radio resource range (see, e.g., FIG. 5) or a range configured to have a predetermined interval from the first radio resource range.

In this case, the size of the second radio resource range may be identified from the size of the first radio resource range, such as 2 times or 3 times the size of the first radio resource range, or may be a constant size configured in advance as a specification. In this case, for example, the first terminal 101 and the second terminal 102 are able to identify the second radio resource range from the first radio resource range identified from the broadcast information. This enables the first terminal 101 and the second terminal 102 to identify the second radio resource range without broadcasting information that indicates the second radio resource range, so that the amount of information of a broadcast signal may be reduced.

The second radio resource range may be the entire radio frame or may be a range of a portion of the entire radio frame as in the case with the first radio resource range. In the latter case, for example, when the radio resources in the second radio resource range are assigned as depicted in FIGS. 2B, 3B, and 4B, the amount of the assignment information notifying the first terminal 101 of the assignment result with respect to the radio resources in the second radio resource range may also be reduced.

The base station 110 may broadcast the second radio resource range along with the first radio resource range. In this case, for example, the base station 110 transmits to the first terminal 101, the assignment information that indicates the assigned radio resources in the second radio resource range in terms of relative positions in the second radio resource range.

In this case, the first terminal 101 is able to identify the radio resources in the second radio resource range assigned by the base station 110, based on the second radio resource range broadcasted from the base station 110 and the relative positions indicated by the assignment information. Therefore, the amount of the assignment information may be reduced.

The first terminal 101 may transmit to the second terminal 102, a control signal that indicates the radio resources in the second radio resource range in terms of relative positions in the second radio resource range. In this case, the second terminal 102 is able to identify the radio resources in the second radio resource range based on the second radio resource range broadcasted from the base station 110 and the relative positions indicated by the control signal. Therefore, the amount of information of the control signal may be reduced.

FIG. 5 is a diagram of an example of a radio frame. For example, a radio frame 500 depicted in FIG. 5 represents radio resources of uplink (UL) frequency in the frequency division duplex (FDD). In the radio frame 500, the horizontal direction indicates time and the vertical direction indicates frequency.

The radio frame 500 includes a UL control information resource 501 (UL control information), a UL data resource 502 (UL data), and a RACH 503, for example. The UL control information resource 501 is a radio resource for the first terminal 101 and the second terminal 102 to transmit a control signal to the base station 110. The UL data resource 502 is a radio resource for the first terminal 101 and the second terminal 102 to transmit data to the base station 110. The RACH 503 is a radio resource for the first terminal 101 and the second terminal 102 to perform random access to the base station 110.

The radio frame 500 also includes a first radio resource range 504 and a second radio resource range 505. The first radio resource range 504 is a range of radio resources used at the start of the terminal-to-terminal communication between the first terminal 101 and the second terminal 102. The first radio resource range 504 is a range of radio resources of which the first terminal 101 and the second terminal 102 are notified by the base station 110 through DL broadcast information, for example.

The second radio resource range 505 is a range of radio resources used for the terminal-to-terminal communication between the first terminal 101 and the second terminal 102 when a large amount of radio resources is required for the terminal-to-terminal communication between the first terminal 101 and the second terminal 102. The second radio resource range 505 may be a range that is wider than the first radio resource range 504, for example.

In the FDD, radio waves different in frequency are used for the downlink (DL) from the base station 110 to the terminals (the first terminal 101 and the second terminal 102) and the UL from the terminals to the base station 110.

The terminal-to-terminal communication between the first terminal 101 and the second terminal 102 may be performed by using a portion of DL frequency resources, a portion of UL frequency resources, or third frequency resources different from the DL and UL frequency resources, for example. In this description, as depicted in FIG. 5, the terminal-to-terminal communication is performed by using the UL frequency resources (the first radio resource range 504 and the second radio resource range 505).

At the DL frequency, various types of control information including frame synchronization symbols and broadcast information are transmitted from the base station 110 to the terminals, and the user data addressed to the terminals are transmitted from the base station 110.

The broadcast information from the base station 110 includes information transmitted at a predetermined position in a DL radio frame and information transmitted to all the terminals as a portion of a data channel. In the specifications of the cellular radio prescribed by 3GPP, the former broadcast information is called the master information block (MIB). The MIB is transmitted in a PBCH area defined in the DL radio frame 500. The latter broadcast information is called the system information block (SIB). The SIB is transmitted through the PDSCH indicated by control information received by all the terminals.

At the UL frequency, the radio resources are divided as in the radio frame 500, and the terminals assigned with the divided radio resources from the base station 110 transmit the control information and the user data to the base station 110. In a portion of the divided radio resources, a radio resource assigned to no certain terminal is ensured as a RACH 503.

For example, the RACH 503 is used for transmitting a request signal for the terminals to request radio resources for new communication. For example, when the terminals are powered on from power-off or the terminals moved from another area request connection to the base station 110, the RACH 503 is used for transmitting a request signal to the base station 110.

For example, a conventional terminal performing no terminal-to-terminal communication does not need to receive a radio resource other than the radio resources assigned for receiving/transmitting control information and user data and the radio resources configured as random access channels transmitting various request signals.

In contrast, if terminal-to-terminal communication using the UL frequency is performed, the base station 110 notifies the terminals of the first radio resource range 504 for receiving the terminal-to-terminal communication, through the first radio resource range information. This first radio resource range information is transmitted through broadcast information transmitted to the terminal at the DL frequency, for example. For example, the first radio resource range information can be transmitted by using the PDSCH received by the terminals as a portion of the SIB or the PBCH received by the terminals as a portion of the MIB.

When receiving the first radio resource range information, each of the terminals performing the terminal-to-terminal communication enables a receiving operation for the first radio resource range indicated by the first radio resource range information and waits for a signal from the other terminal so as to directly receive a radio signal from the other terminal.

To avoid interference, the radio resources in the first radio resource range assigned by the base station 110 are desirably excluded from the radio resources assigned for transmitting signals from the first terminal 101, the second terminal 102, or other terminals to the base station 110. However, the base station 110 may even assign a radio resource within the first radio resource range configured for performing the terminal-to-terminal communication, as a radio resource for transmitting a signal to the base station 110 as in the conventional case.

Additionally, the radio resources in the second radio resource range may not exclusively be used for the terminal-to-terminal communication as is the case with the radio resources in the first radio resource range, and may be assigned to the other terminal as normal radio resources for transmitting signals to the base station 110. In this case, although a limitation of the total number of radio resources exists as a condition, configuration of the second radio resource range does not limit a degree of freedom of radio resource assignment to communication of the wireless communications system 100 with the first terminal 101 and the second station 102.

Although the first radio resource range 504 and the second radio resource range 505 are divided in the time direction in the description of the example depicted in FIG. 5, this is not a limitation of the first radio resource range 504 and the second radio resource range 505. For example, the first radio resource range 504 and the second radio resource range 505 may be radio resource ranges divided in the frequency direction or divided by the combination of the time direction and the frequency direction.

Although the first radio resource range 504 and the second radio resource range 505 are configured in the radio resource range of the UL of FDD in the description, the first radio resource range 504 and the second radio resource range 505 may be configured in the DL of FDD. Alternatively, one of the first radio resource range 504 and the second radio resource range 505 may be configured in the DL of FDD and the other may be configured in the UL of FDD. One or both of the first radio resource range 504 and the second radio resource range 505 may be configured as a radio resource range of a frequency band different from the frequency band used for communication of the base station 110 with the first terminal 101 and the second terminal 102.

In the time division duplex (TDD), the first radio resource range 504 and the second radio resource range 505 may be configured as a portion of the radio resource range. Alternatively, one or both of the first radio resource range 504 and the second radio resource range 505 may be configured as a radio resource range of a frequency band different from the frequency band used for communication between the base station 110 and the first terminal 101 or the second terminal 102.

FIG. 6A is a diagram of an example of a format of the first radio resource range information transmitted by the base station. For example, at step S211 of FIG. 2A, the base station 110 transmits, for example, a message 610 depicted in FIG. 6A as the first radio resource range information.

The message 610 is a data block including a SIB identifier area 611, a radio resource range information identifier area 612, a symbol area 613, a PRB number area 614, and a PRB count area 615.

The SIB identifier area 611 stores an identifier indicating that the message 610 is the SIB. The radio resource range information identifier area 612 stores an identifier indicating that the message 610 is the first radio resource range information that indicates the first radio resource range.

The symbol area 613 stores a symbol number of the start position of the first radio resource range. The PRB number area 614 stores a physical resource block (PRB) number of the start position of the first radio resource range. The PRB count area 615 stores the number of PRBs of the first radio resource range.

The base station 110 may transmit the message 610 to broadcast the first radio resource range to the first terminal 101 and the second terminal 102. For example, the first terminal 101 and the second terminal 102 may identify the first radio resource range based on the start position of the first radio resource range indicated by the symbol area 613 and the PRB number area 614 and the number of PRBs of the first radio resource range indicated by the PRB count area 615.

When transmitting the second radio resource range information that indicates the second radio resource range, the base station 110 may transmit the message 610 as the second radio resource range information. In this case, the radio resource range information identifier area 612 stores an identifier indicating that the message 610 is the second radio resource range information that indicates the second radio resource range.

The symbol area 613 stores a symbol number of the start position of the second radio resource range. The PRB number area 614 stores a PRB number of the start position of the second radio resource range. The PRB count area 615 stores the number of PRBs of the first radio resource range.

FIG. 6B is a diagram of an example of a format of assignment information transmitted by the base station. For example, at step S213 of FIG. 2A, the base station 110 individually transmits, for example, a message 620 depicted in FIG. 6B as the assignment information to the first terminal 101.

The message 620 includes a resource assignment information identifier area 621, a PRB bitmap area 622, an additional radio resource area 623, a symbol area 624, a PRB number area 625, a PRB count area 626, and a PRB bitmap area 627.

The resource assignment information identifier area 621 stores an identifier indicating that the message 620 is assignment information that indicates an assignment result of radio resources for terminal-to-terminal communication. Therefore, the resource assignment information identifier area 621 is information indicating that the message 620 is information that indicates the radio resources assigned by the base station 110 to the terminal-to-terminal communication.

The PRB bitmap area 622 stores a table of the bit count indicated by the PRB count area 615 depicted in FIG. 6A and the table describes the presence/absence of resource assignment in the first radio resource range for each PRB. Therefore, the PRB bitmap area 622 is information that indicates the radio resources in the first radio resource range assigned by the base station 110 in terms of relative positions in the first radio resource range.

The additional radio resource area 623 stores information that indicates the presence/absence of resource assignment in the second radio resource range. The symbol area 624 stores a symbol number of the start position of the second radio resource range. The PRB number area 625 stores a PRB number of the start position of the second radio resource range.

The PRB count area 626 stores the number of PRBs in the second radio resource range. The PRB bitmap area 627 stores a table of the bit count indicated by the PRB count area 626 and the table describes the presence/absence of resource assignment in the second radio resource range for each PRB. Therefore, the PRB bitmap area 627 is information that indicates the radio resources in the second radio resource range assigned by the base station 110 in terms of relative positions in the second radio resource range.

When the information that indicates the absence of resource assignment in the second radio resource range is stored in the additional radio resource area 623, the information of the symbol area 624, the PRB number area 625, and the PRB count area 626 may be omitted.

The base station 110 may use the message 620 to notify the first terminal 101 of the assigned radio resources in the first radio resource range. For example, the first terminal 101 is able identify the radio resources in the first radio resource range assigned from the base station 110 based on the first radio resource range identified from the message 610 depicted in FIG. 6A and the PRB bitmap area 622. For example, the first terminal 101 is able to determine that, among the PRBs included in the first radio resource range, PRBs associated with the presence of the assignment indicated by the PRB bitmap area 622 are the radio resources in the first radio resource range assigned from the base station 110.

If the radio resources in the second radio resource range are assigned, the base station 110 may use the message 620 to notify the first terminal 101 of the assigned radio resources in the second radio resource range. For example, the first terminal 101 is able to identify the second radio resource range based on the start position of the second radio resource range indicated by the symbol area 624 and the PRB number area 625 as well as the number of PRBs in the second radio resource range indicated by the PRB count area 626. The first terminal 101 is able to then identify the radio resources in the second radio resource range assigned from the base station 110, based on the identified second radio resource range and the PRB bitmap area 627. For example, the first terminal 101 is able to determine that, among the PRBs included in the second radio resource range, PRBs associated with the presence of the assignment indicated by the PRB bitmap area 627 are the radio resources in the second radio resource range assigned from the base station 110.

If the base station 110 broadcasts the second radio resource range through the message 610 depicted in FIG. 6A, the first terminal 101 is able to identify the second radio resource range from the message 610. Therefore, in this case, the message 620 may omit the symbol area 624, the PRB number area 625, and the PRB count area 626.

FIG. 6C is a diagram of an example of a signal transmitted by the first terminal to the second terminal. When transmitting data to the second station 102 in a case where the radio resources in the second radio resource range are not assigned by the base station 110, the first terminal 101 transmits, for example, a message 630 depicted in FIG. 6C to the second terminal 102 at step S214 depicted in FIG. 2A, for example.

The message 630 is a data block including a transmission source terminal identifier area 631, a transmission destination terminal identifier area 632, an additional radio resource information area 633, and a user data area 634.

The transmission source terminal identifier area 631 stores an identifier of the first terminal 101 that is the transmission source of the message 630. The transmission destination terminal identifier area 632 stores an identifier of the second terminal 102 that is the transmission destination terminal of the message 630.

The additional radio resource information area 633 stores the presence/absence of the radio resource information of the second radio resource range. For example, if “0” is stored in the additional radio resource information area 633, this indicates the absence of the radio resource information of the second radio resource range. If “1” is stored in the additional radio resource information area 633, this indicates the presence of the radio resource information of the second radio resource range.

In the example depicted in FIG. 6C, no radio resource in the second radio resource range is assigned to the terminal-to-terminal communication between the first terminal 101 and the second terminal 102 (see FIG. 2A) and “0” is therefore stored in the additional radio resource information area 633.

The user data area 634 stores user data (communication content data) from the first terminal 101 to the second terminal 102.

FIG. 6D is a diagram of another example of the signal transmitted by the first terminal to the second terminal. When transmitting data to the second station 102 in a case where the radio resources in the second radio resource range are assigned by the base station 110, the first terminal 101 transmits, for example, a message 640 depicted in FIG. 6D to the second terminal 102 at step S224 depicted in FIG. 2B, for example. In the message 640, the same portions as those of the message 630 depicted in FIG. 6C will not be described.

The message 640 includes the transmission source terminal identifier area 631, the transmission destination terminal identifier area 632, and the additional radio resource information area 633. The message 640 also includes a symbol area 641, a PRB number area 642, a PRB count area 643, a PRB bitmap area 644, a T/R table area 645, and the user data area 634.

In the example depicted in FIG. 6D, the radio resources in the second radio resource range are assigned to the terminal-to-terminal communication between the first terminal 101 and the second terminal 102 (see FIG. 2B) and “1” is therefore stored in the additional radio resource information area 633. The additional radio resource information area 633 in this case is information indicating that the message 630 is information that indicates the radio resources in the second radio resource range.

The symbol area 641 stores a symbol number of the start position of the second radio resource range. The PRB number area 642 stores a PRB number of the start position of the second radio resource range. The PRB count area 643 stores the number of PRBs in the second radio resource range.

The PRB bitmap area 644 stores a table of the bit count indicated by the PRB count area 643 and the table describes the presence/absence of resource assignment in the second radio resource range for each PRB. Therefore, the PRB bitmap area 644 is information that indicates the radio resources in the second radio resource range assigned by the base station 110 in terms of relative positions in the second radio resource range.

The T/R table area 645 stores a table of the number of PRBs having assignment indicated by the PRB bitmap area 644. The table stored in the T/R table area 645 is a table describing whether the respective PRBs having the assignment is used for transmission (T) by the first terminal 101 or reception (R) by the first terminal 101, i.e., transmission by the second terminal 102.

For example, the second terminal 102 is able to identify the second radio resource range based on the start position of the second radio resource range indicated by the symbol area 641 and the PRB number area 642 as well as the number of PRBs of the second radio resource range indicated by the PRB count area 643.

The second terminal 102 may then identify the radio resources in the second radio resource range assigned from the base station 110 based on the identified second radio resource range and the PRB bitmap area 644. For example, the second terminal 102 is able to determine that, among the PRBs included in the second radio resource range, PRBs associated with the presence of the assignment indicated by the PRB bitmap area 644 are the radio resources in the second radio resource range assigned from the base station 110.

Additionally, the second terminal 102 is able to identify the radio resources used for transmission by the first terminal 101 and the radio resources used for transmission by the second terminal 102 among the assigned radio resources in the second radio resource range based on the T/R table area 645.

If the base station 110 broadcasts the second radio resource range through the message 610 depicted in FIG. 6A, the second terminal 102 is able to identify the second radio resource range from the message 610. Therefore, in this case, the message 640 may omit the symbol area 641, the PRB number area 642, and the PRB count area 643.

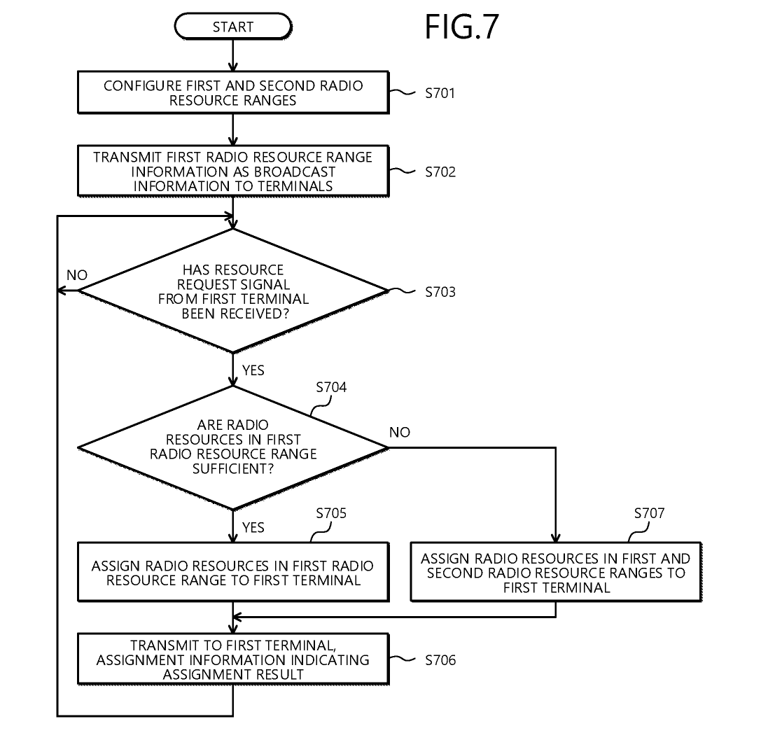

FIG. 7 is a flowchart of an example of a process by the base station. The process of the base station 110 described with reference to FIG. 7 corresponds to the operation depicted in FIGS. 2A and 2B, for example. The base station 110 executes steps depicted in FIG. 7, for example.

First, the base station 110 configures a radio frame to configure the first radio resource range and the second radio resource range (step S701). The radio frame configured at step S701 includes the radio frame 500 depicted in FIG. 5, for example.

The base station 110 then transmits the first radio resource range information that indicates the first radio resource range configured at step S701 as broadcast information to terminals (e.g., the first terminal 101 and the second terminal 102) (step S702).

The base station 110 then determines whether a resource request signal from the first terminal 101 has been received (step S703), and waits until receiving a resource request signal (step S703: NO). A resource request signal is a signal requesting the base station 110 to assign radio resources for use in terminal-to-terminal communication between the first terminal 101 and the second terminal 102.

At step S703, when receiving a resource request signal (step S703: YES), the base station 110 determines whether the radio resources in the first radio resource range are sufficient for the resource request signal from the first terminal 101 (step S704). For example, the base station 110 may make the determination at step S704 depending on whether the amount of the radio resources required for the terminal-to-terminal communication between the first terminal 101 and the second terminal 102 is less than a predetermined amount. For example, the predetermined amount may be an amount of current free resources in the first radio resource range.

At step S704, if the radio resources in the first radio resource range are sufficient (step S704: YES), the base station 110 assigns the radio resources in the first radio resource range to the first terminal 101 (step S705). The base station 110 then transmits to the first terminal 101, the assignment information that indicates the assignment result of the radio resources to the first terminal 101 (step S706) and returns to step S703.

At step S704, when the radio resources in the first radio resource range are insufficient (step S704: NO), the base station 110 assigns the radio resources in the first radio resource range and the second radio resource range to the first terminal 101 (step S707). The base station 110 then goes to step S706 and transmits to the first terminal 101 the assignment information that indicates the assignment result of radio resources to the first terminal 101.

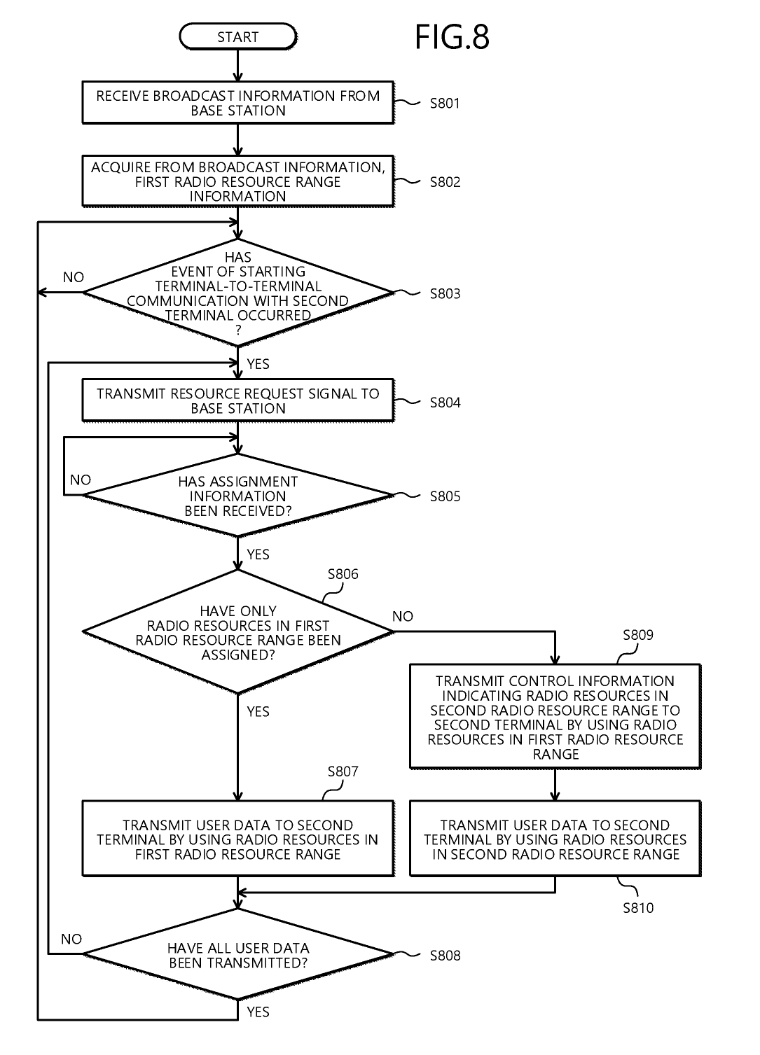

FIG. 8 is a flowchart of an example of a process by the first terminal. The process of the first terminal 101 described with reference to FIG. 8 corresponds to the operation depicted in FIGS. 2A and 2B, for example. The first terminal 101 executes steps depicted in FIG. 8, for example.

First, the first terminal 101 receives broadcast information from the base station 110 (step S801). The first terminal 101 then acquires from the broadcast information received at step S801, the first radio resource range information that indicates the first radio resource range (step S802).

The first terminal 101 then determines whether an event of starting the terminal-to-terminal communication with the second terminal 102 has occurred (step S803), and waits until an event of starting the terminal-to-terminal communication occurs (step S803: NO). An event of starting the terminal-to-terminal communication is, for example, a terminal-to-terminal communication starting instruction operation to the first terminal 101 by the user of the first terminal 101. Not only does the user of the first terminal 101 directly perform the terminal-to-terminal communication starting instruction operation, but also an application program executed on the terminal may request the start of the terminal-to-terminal communication in some cases.

When an event of starting the terminal-to-terminal communication has occurred at step S803 (step S803: YES), the first terminal 101 transmits a resource request signal requesting assignment of radio resources for use in the terminal-to-terminal communication to the base station 110 (step S804).

The first terminal 101 then determines whether the assignment information from the base station 110 has been received (step S805), and waits until receiving the assignment information (step S805: NO). Although not explicitly depicted in FIG. 8, if assignment information is not received even after a predetermined time has elapsed, the first terminal 101 may return to step S804 to retransmit the resource request signal. A process for such an abnormal state may separately be added at other steps.

When receiving the assignment information at step S805 (step S805: YES), the first terminal 101 determines based on the received assignment information whether only the radio resources in the first radio resource range are assigned by the base station 110 (step S806).

At step S806, if only the radio resources in the first radio resource range are assigned (step S806: YES), the first terminal 101 goes to step S807. In particular, the first terminal 101 transmits user data to the second terminal 102 by using the radio resources in the first radio resource range indicated by the received assignment information (step S807).

The first terminal 101 then determines whether all the user data to be transmitted to the second terminal 102 are transmitted (step S808). If not all the user data are transmitted (step S808: NO), the first terminal 101 returns to step S804. If all the user data are transmitted (step S808: YES), the first terminal 101 returns to step S803.

If the radio resources in the first radio resource range and the second radio resource range are assigned at step S806 (step S806: NO), the first terminal 101 goes to step S809. In particular, the first terminal 101 transmits control information that indicates the radio resources in the second radio resource range to the second terminal 102 by using the radio resources in the first radio resource range indicated by the received assignment information (step S809).

The first terminal 101 then transmits the user data to the second terminal 102 by using the radio resources in the second radio resource range indicated by the control information transmitted at step S809 (step S810) and goes to step S808.

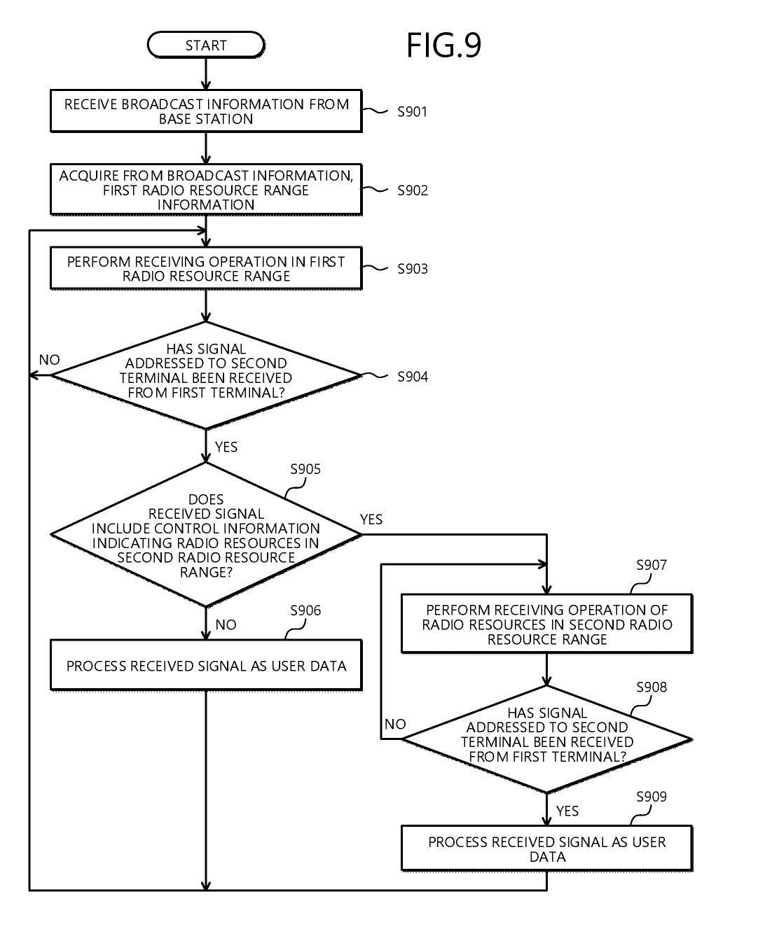

FIG. 9 is a flowchart of an example of a process by the second terminal. The process of the second terminal 102 described with reference to FIG. 9 corresponds to the operation depicted in FIGS. 2A and 2B, for example. The second terminal 102 executes steps depicted in FIG. 9, for example.

First, the second terminal 102 receives broadcast information from the base station 110 (step S901). The second terminal 102 then acquires from the broadcast information received in step S901, the first radio resource range information that indicates the first radio resource range (step S902).

The second terminal 102 then performs a receiving operation in the first radio resource range indicated by the first radio resource range information acquired at step S902 (step S903). The second terminal 102 may execute the process at step S903 after an event of starting the terminal-to-terminal communication with the first terminal 101 has occurred. An event of starting the terminal-to-terminal communication is, for example, a terminal-to-terminal communication starting instruction operation to the second terminal 102 by the user of the second terminal 102. An application program executed on the second terminal 102 may request the start of the terminal-to-terminal communication in some cases.

The second terminal 102 then determines whether a signal addressed to the second terminal 102 from the first terminal 101 has been received through the receiving operation at step S903 (step S904). If a signal from the first terminal 101 has not been received (step S904: NO), the second terminal 102 returns to step S903.

If a signal from the first terminal 101 has been received at step S904 (step S904: YES), the second terminal 102 determines whether the received signal includes control information that indicates the radio resources in the second radio resource range (step S905).

At step S905, if control information that indicates the radio resources in the second radio resource range is not included (step S905: NO), it can be determined that the received signal is the user data from the first terminal 101. In this case, the second terminal 102 processes the received signal as user data in a processing unit of the higher layer, for example (step S906), and returns to step S903.

If control information that indicates the radio resources in the second radio resource range is included at step S905 (step S905: YES), the second terminal 102 performs a receiving operation of the radio resources in the second radio resource range indicated by the received control information (step S907).

The second terminal 102 then determines whether a signal addressed to the second terminal 102 from the first terminal 101 has been received through the receiving operation at step S907 (step S908). If a signal from the first terminal 101 has not been received (step S908: NO), the second terminal 102 returns to step S907.

If a signal from the first terminal 101 has been received at step S908 (step S908: YES), the second terminal 102 processes the received signal as user data in the processing unit of the higher layer, for example (step S909), and returns to S903.

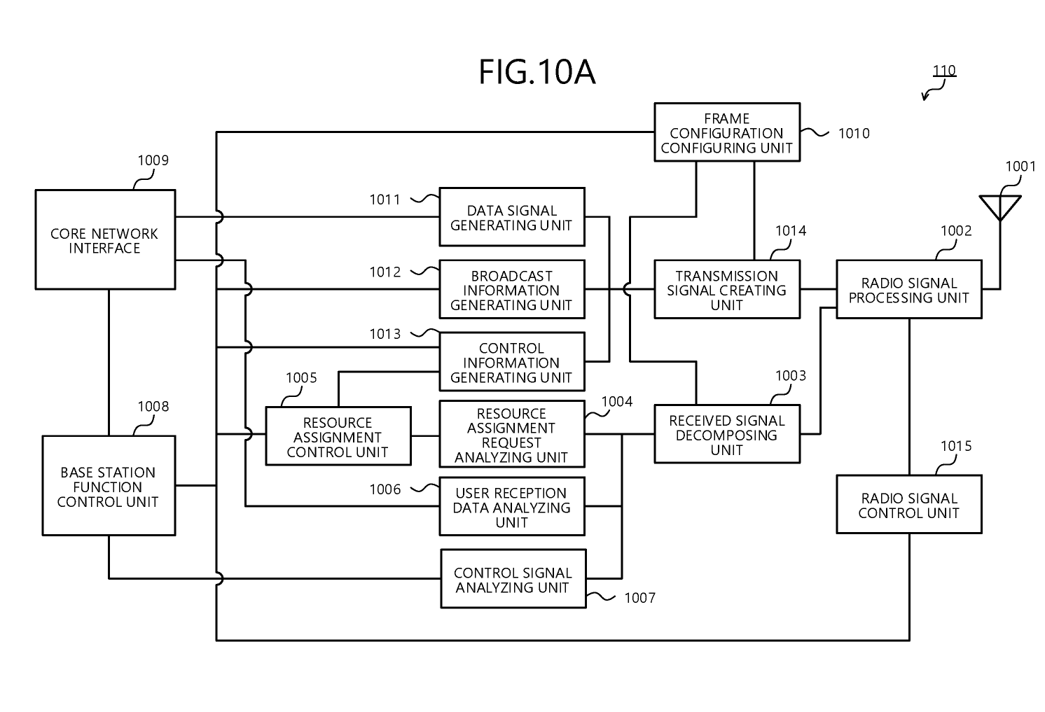

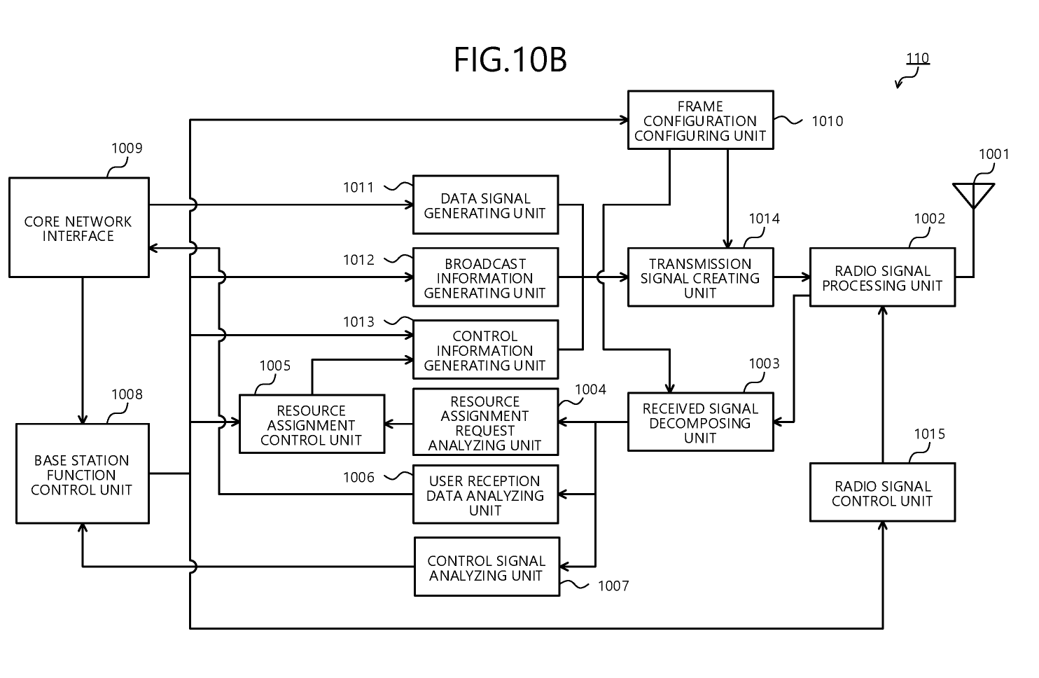

FIG. 10A is a diagram of an example of a configuration of the base station. FIG. 10B is a diagram of an example of signal flow in the configuration of the base station depicted in FIG. 10A. For example, as depicted in FIGS. 10A and 10B, the base station 110 includes an antenna 1001, a radio signal processing unit 1002, a received signal decomposing unit 1003, a resource assignment request analyzing unit 1004, a resource assignment control unit 1005, and a user reception data analyzing unit 1006. The base station 110 also includes a control signal analyzing unit 1007, a base station function control unit 1008, a core network interface 1009, and a frame configuration configuring unit 1010. The base station 110 further includes a data signal generating unit 1011, a broadcast information generating unit 1012, a control information generating unit 1013, a transmission signal creating unit 1014, and a radio signal control unit 1015.

The antenna 1001 receives a signal wirelessly transmitted from a communications device different from the base station 110 and outputs the received signal to the radio signal processing unit 1002. The antenna 1001 wirelessly transmits to a communications device different from the base station 110, a signal output from the radio signal processing unit 1002. A communications device different from the base station 110 is a terminal such as the first terminal 101 and the second terminal 102, for example.

The radio signal processing unit 1002 executes a reception process of the signal output from the antenna 1001 under the control of the radio signal control unit 1015. The reception process by the radio signal processing unit 1002 includes, for example, amplification, frequency conversion from the radio frequency (RF) band into a baseband, and conversion from an analog signal into a digital signal. The radio signal processing unit 1002 outputs a signal subjected to the reception process to the reception signal decomposing unit 1003.

The radio signal processing unit 1002 also executes a transmission process of a signal output from the transmission signal creating unit 1014 under the control of the radio signal control unit 1015. The transmission process by the radio signal processing unit 1002 includes, for example, conversion from a digital signal into an analog signal, frequency conversion from the baseband to the RF band, and amplification. The radio signal processing unit 1002 outputs a signal subjected to the transmission process to the antenna 1001.

The reception signal decomposing unit 1003 executes a decomposing process of the signal output from the radio signal processing unit 1002, based on a frame configuration configuring result output from the frame configuration configuring unit 1010. The reception signal decomposing unit 1003 outputs to the resource assignment request analyzing unit 1004, a resource request signal acquired from the decomposing process.

The reception signal decomposing unit 1003 outputs to the user reception data analyzing unit 1006, user data acquired from the decomposing process. The reception signal decomposing unit 1003 outputs to the control signal analyzing unit 1007, a control signal acquired from the decomposing process.

The resource assignment request analyzing unit 1004 analyzes the resource request signal output from the reception signal decomposing unit 1003 and outputs an analysis result to the resource assignment control unit 1005.

The resource assignment control unit 1005 determines an assignment amount of radio resources required for terminal-to-terminal communication between the first terminal 101 and the second terminal 102, based on the analysis result output from the resource assignment request analyzing unit 1004 under the control of the base station function control unit 1008. For example, the resource assignment control unit 1005 determines an assignment amount of radio resources required for terminal-to-terminal communication between the first terminal 101 and the second terminal 102 from the analysis result of the resource request signal.

If the determined assignment amount is equal to or smaller than a predetermined amount, the resource assignment control unit 1005 assigns only the radio resources in the first radio resource range to the terminal-to-terminal communication between the first terminal 101 and the second terminal 102. If the determined assignment amount exceeds the predetermined amount, the resource assignment control unit 1005 assigns the radio resources in the first radio resource range and the second radio resource range to the terminal-to-terminal communication between the first terminal 101 and the second terminal 102. The resource assignment control unit 1005 outputs to the control information generating unit 1013, assignment information that indicates the radio resources assigned to the terminal-to-terminal communication between the first terminal 101 and the second terminal 102.

The user reception data analyzing unit 1006 analyzes the user data output from the reception signal decomposing unit 1003 and outputs the analyzed user data to the core network interface 1009. The user data includes, for example, the user data transmitted from the first terminal 101 and the second terminal 102.

The control signal analyzing unit 1007 analyzes the control signal output from the reception signal decomposing unit 1003 and notifies the base station function control unit 1008 of the analysis result. The control signal analyzed by the control signal analyzing unit 1007 includes, for example, the control signals transmitted from the first terminal 101 and the second terminal 102.

Based on the notification result from the control signal analyzing unit 1007, the base station function control unit 1008 controls the resource assignment control unit 1005, the frame configuration configuring unit 1010, the broadcast information generating unit 1012, the control information generating unit 1013, and the radio signal control unit 1015. The process of control by the base station function control unit 1008 is controlled by a control signal received through the core network interface 1009 from a higher system of a core network, for example.

The core network interface 1009 is an interface for performing communication with the core network. The core network is a core network of a mobile communication network to which the base station 110 belongs. For example, the core network interface 1009 outputs to the base station function control unit 1008, a control signal for the base station function control unit 1008 received from the higher system of the core network.

The core network interface 1009 transmits the user data output from the user reception data analyzing unit 1006 to the core network. The core network interface 1009 outputs the signal received from the core network to the data signal generating unit 1011. The signal output by the core network interface 1009 to the data signal generating unit 1011 includes user data to the first terminal 101 and the second terminal 102.

The frame configuration configuring unit 1010 configures a frame configuration in the cell 111 under the control of the base station function control unit 1008. The frame configuration is a frame configuration including the radio frame 500 depicted in FIG. 5, for example. The frame configuration configuring unit 1010 outputs the result of the frame configuration to the reception signal decomposing unit 1003 and the transmission signal creating unit 1014.

The data signal generating unit 1011 generates a data signal including the user data output from the core network interface 1009 and outputs the generated data signal to the transmission signal creating unit 1014. The broadcast information generating unit 1012 generates broadcast information to be transmitted by the base station 110 and outputs the generated broadcast information to the transmission signal creating unit 1014 under the control of the base station function control unit 1008.

Under the control of the base station function control unit 1008, the control information generating unit 1013 generates control information to be transmitted from the base station 110 to the first terminal 101 and the second terminal 102 and outputs the generated control information to the transmission signal creating unit 1014. The control information output by the control information generating unit 1013 includes the assignment information output from the resource assignment control unit 1005.

The transmission signal creating unit 1014 creates a signal including the data signal output from the data signal generating unit 1011, the broadcast information output from the broadcast information generating unit 1012, and the control information output from the control information generating unit 1013. The transmission signal creating unit 1014 creates the signal by assigning the pieces of the information to the signal based on the result of the frame configuration output from the frame configuration configuring unit 1010.

The transmission signal creating unit 1014 stores the first radio resource range information that indicates the first radio resource range included in the frame configuration configuring result output from the frame configuration configuring unit 1010, into the broadcast information of the signal to be created. The transmission signal creating unit 1014 outputs the created signal to the radio signal processing unit 1002.

The radio signal control unit 1015 controls the reception process at the radio signal processing unit 1002 under the control of the base station function control unit 1008. For example, the radio signal control unit 1015 controls the frequency, the gain of an amplifier, etc. of the signal received by the radio signal processing unit 1002.

The radio signal control unit 1015 also controls the transmission process at the radio signal processing unit 1002 under the control of the base station function control unit 1008. For example, the radio signal control unit 1015 controls the frequency, electric power, etc. of the signal transmitted by the radio signal processing unit 1002.

In the base station 110 depicted in FIGS. 10A and 10B, a broadcasting apparatus that transmits the broadcast information for broadcasting a first range of radio resources may be implemented by the antenna 1001, the radio signal processing unit 1002, the broadcast information generating unit 1012, and the transmission signal creating unit 1014. An assigning apparatus that assigns radio resources to the terminal-to-terminal communication between the first terminal 101 and the second terminal 102 may be implemented by the resource assignment control unit 1005 and the base station function control unit 1008. A transmitting apparatus that transmits the assignment information that indicates the radio resources assigned by the assigning apparatus to the first terminal 101 may be implemented by the antenna 1001, the radio signal processing unit 1002, the control information generating unit 1013, and the transmission signal creating unit 1014.

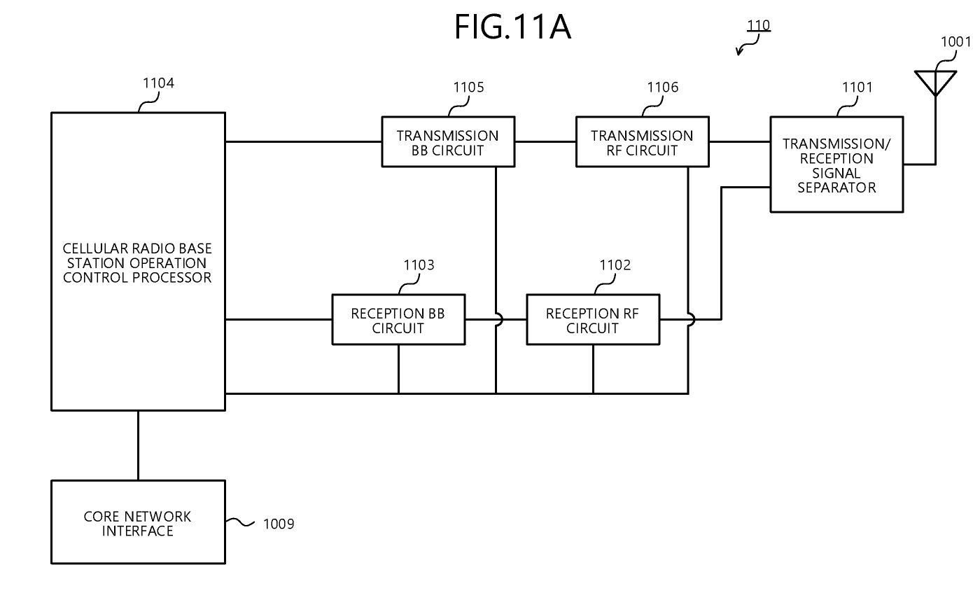

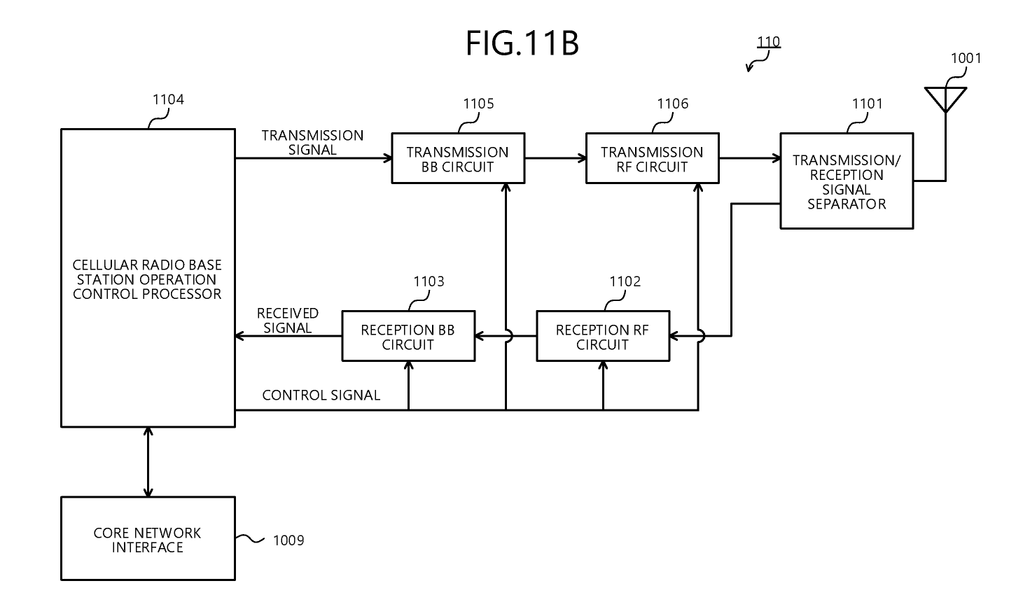

FIG. 11A is a diagram of an example of a hardware configuration of the base station. FIG. 11B is a diagram of an example of signal flow in the hardware configuration of the base station depicted in FIG. 11A. In FIGS. 11A and 11B, portions identical to those depicted in FIGS. 10A and 10B are denoted by the same reference numerals used in FIGS. 10A and 10B and will not be described. For example, as depicted in FIGS. 11A and 11B, the base station 110 includes the antenna 1001, a transmission/reception signal separator 1101, a reception RF circuit 1102, a reception BB circuit 1103, and a cellular radio base station operation control processor 1104. The base station 110 also includes the core network interface 1009, a transmission BB circuit 1105, and a transmission RF circuit 1106.

The transmission/reception signal separator 1101 outputs to the reception RF circuit 1102, a signal output from the antenna 1001 and outputs to the antenna 1001, a signal output from the transmission RF circuit 1106, thereby separating the signals transmitted and received by the antenna 1001.

The reception RF circuit 1102 executes a reception process in the RF band for the signal output from the transmission/reception signal separator 1101 and outputs to the reception BB circuit 1103, the signal subjected to the reception process in the RF band. The reception BB circuit 1103 executes a reception process in the baseband (BB) for the signal output from the transmission/reception signal separator 1101 and outputs to the cellular radio base station operation control processor 1104, a signal (reception signal) subjected to the reception process in the BB.

The cellular radio base station operation control processor 1104 is a processor that manages the overall control of the base station 110. For example, the cellular radio base station operation control processor 1104 transmits control signals to control each of the reception RF circuit 1102, the reception BB Circuit 1103, the transmission BB circuit 1105, and the transmission RF circuit 1106.

The cellular radio base station operation control processor 1104 transmits through the core network interface 1009 to the core network, the reception data output from the reception BB circuit 1103. The cellular radio base station operation control processor 1104 transmits to the transmission BB circuit 1105, a signal (transmission signal) to be transmitted by the base station 110 among signals received through the network interface 1009 from the core network.

The cellular radio base station operation control processor 1104 may be implemented by a processor such as a central processing unit (CPU) or a digital signal processor (DSP), for example.

The transmission BB circuit 1105 executes a transmission process in the BB for the signal output from the cellular radio base station operation control processor 1104 and outputs the signal subjected to the transmission process in the BB to the transmission RF circuit 1106. The transmission RF circuit 1106 executes a transmission process in the RF band for the signal output from the transmission BB circuit 1105 and outputs the signal subjected to the transmission process in the RF band to the transmission/reception signal separator 1101.

The radio signal processing unit 1002 depicted in FIGS. 10A and 10B may be implemented by the reception RF circuit 1102, the reception BB circuit 1103, the transmission BB circuit 1105, and the transmission RF circuit 1106, for example. The reception signal decomposing unit 1003, the resource assignment request analyzing unit 1004, the resource assignment control unit 1005, and the user reception data analyzing unit 1006 depicted in FIGS. 10A and 10B may be implemented by the cellular radio base station operation control processor 1104, for example.

The control signal analyzing unit 1007, the base station function control unit 1008, the frame configuration configuring unit 1010, and the data signal generating unit 1011 depicted in FIGS. 10A and 10B may be implemented by the cellular radio base station operation control processor 1104, for example. The broadcast information generating unit 1012, the control information generating unit 1013, the transmission signal creating unit 1014, and the radio signal control unit 1015 depicted in FIGS. 10A and 10B may be implemented by the cellular radio base station operation control processor 1104, for example.

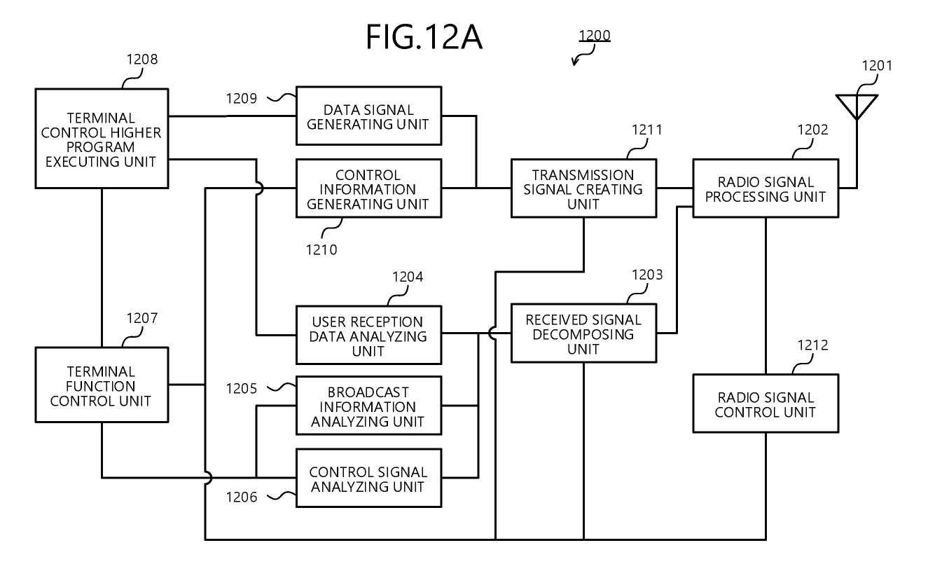

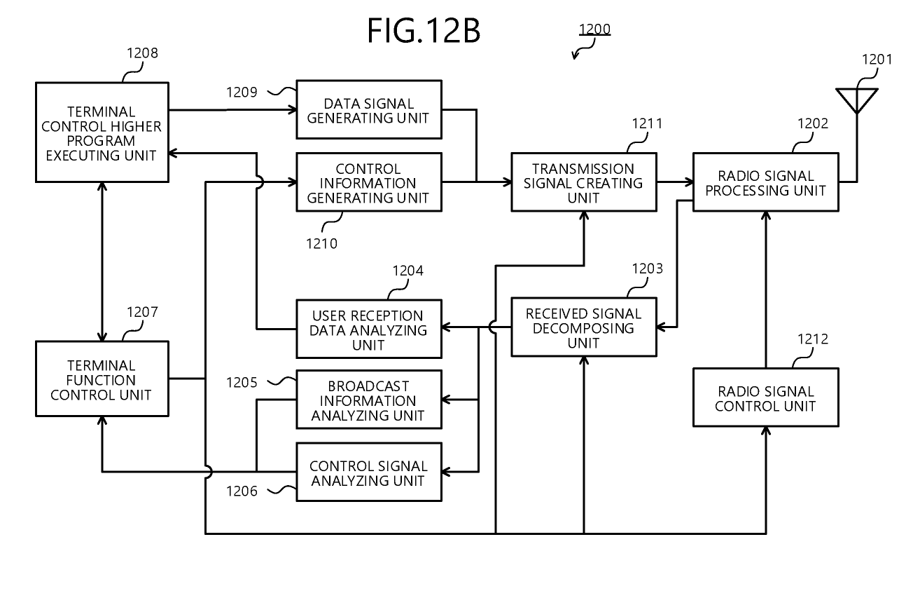

FIG. 12A is a diagram of an example of a terminal configuration. FIG. 12B is a diagram of an example of signal flow in the terminal configuration depicted in FIG. 12A. The first terminal 101 and the second terminal 102 may each be implemented by a terminal 1200 depicted in FIGS. 12A and 12B, for example. The terminal 1200 includes an antenna 1201, a radio signal processing unit 1202, a reception signal decomposing unit 1203, a user reception data analyzing unit 1204, a broadcast information analyzing unit 1205, a control signal analyzing unit 1206, and a terminal function control unit 1207. The terminal 1200 also includes a terminal control higher program executing unit 1208, a data signal generating unit 1209, a control information generating unit 1210, a transmission signal creating unit 1211, and a radio signal control unit 1212.

The antenna 1201 receives a signal wirelessly transmitted from a communications device different from the terminal 1200 and outputs the received signal to the radio signal processing unit 1202. The antenna 1201 wirelessly transmits to a communications device different from the terminal 1200, a signal output from the radio signal processing unit 1202. The communications device different from the terminal 1200 is another terminal or the base station 110, for example.

The radio signal processing unit 1202 executes a reception process of the signal output from the antenna 1201, under the control of the radio signal control unit 1212. The reception process by the radio signal processing unit 1202 includes, for example, amplification, frequency conversion from the RF band into the baseband, and conversion from an analog signal into a digital signal. The radio signal processing unit 1202 outputs the signal subjected to the reception process to the reception signal decomposing unit 1203.

The radio signal processing unit 1202 also executes a transmission process of a signal output from the transmission signal creating unit 1211, under the control of the radio signal control unit 1212. The transmission process by the radio signal processing unit 1202 includes, for example, conversion from a digital signal into an analog signal, frequency conversion from the baseband to the RF band, and amplification. The radio signal processing unit 1202 outputs the signal subjected to the transmission process to the antenna 1201.

The reception signal decomposing unit 1203 executes a decomposing process of the signal output from the radio signal processing unit 1202, under the control of the terminal function control unit 1207. For example, the reception signal decomposing unit 1203 executes the decomposing process based on a DL frame configuration etc. reported from the terminal function control unit 1207. The reception signal decomposing unit 1203 outputs user data acquired from the decomposing process to the user reception data analyzing unit 1204. The reception signal decomposing unit 1203 outputs broadcast information acquired from the decomposing process to the broadcast information analyzing unit 1205. The reception signal decomposing unit 1203 outputs a control signal acquired from the decomposing process to the control signal analyzing unit 1206.

The user reception data analyzing unit 1204 analyzes the user data from the signals output from the reception signal decomposing unit 1203 and outputs the analyzed user data to the terminal control higher program executing unit 1208. The user data includes, for example, the user data transmitted from the base station 110 and the user data transmitted from the other terminal through terminal-to-terminal communication.

The broadcast information analyzing unit 1205 analyzes the broadcast information from the signal output from the reception signal decomposing unit 1203 and notifies the terminal function control unit 1207 of the analysis result. For example, the broadcast information analyzing unit 1205 acquires the first radio resource range information included in the broadcast information and notifies the terminal function control unit 1207 of the first radio resource range indicated by the acquired first radio resource range information.

The control signal analyzing unit 1206 analyzes the control signal from the signals output from the reception signal decomposing unit 1203 and notifies the terminal function control unit 1207 of the analysis result. For example, the control signal analyzing unit 1206 acquires assignment information and control information included in the control signal and notifies the terminal function control unit 1207 of the radio resources indicated by the acquired assignment information and control information.

Based on the notification result from the broadcast information analyzing unit 1205 and the control signal analyzing unit 1206, the terminal function control unit 1207 controls the reception signal decomposing unit 1203, the control information generating unit 1210, the transmission signal creating unit 1211, and the radio signal control unit 1212. The process of control by the terminal function control unit 1207 is controlled by the terminal control higher program executing unit 1208. The terminal function control unit 1207 notifies the terminal control higher program executing unit 1208 of the process result of the control.

The terminal control higher program executing unit 1208 executes a process of the higher layer of communication in the terminal 1200. For example, the terminal control higher program executing unit 1208 executes a process based on the user data output from the user reception data analyzing unit 1204. The terminal control higher program executing unit 1208 outputs to the data signal generating unit 1209, the user data to be transmitted by the terminal 1200 to another communications device.

The data signal generating unit 1209 generates a data signal including the user data output from the terminal control higher program executing unit 1208 and outputs the generated data signal to the transmission signal creating unit 1211. The control information generating unit 1210 generates control information to be transmitted by the terminal 1200 to another communications device and outputs the generated control information to the transmission signal creating unit 1211 under the control of the terminal function control unit 1207. The control signal generated by the control information generating unit 1210 includes the resource request signal described above, for example.

Under the control of the terminal function control unit 1207, the transmission signal creating unit 1211 creates a signal to be transmitted by the terminal 1200 including the data signal output from the data signal generating unit 1209 and the control information output from the control information generating unit 1210. For example, the transmission signal creating unit 1211 creates a signal based on the UL frame configuration, etc. reported from the terminal function control unit 1207. The transmission signal creating unit 1211 outputs the created signal to the radio signal processing unit 1202.

The radio signal control unit 1212 controls the reception processing at the radio signal processing unit 1202, under the control of the terminal function control unit 1207. For example, the radio signal control unit 1212 controls the frequency, the gain of an amplifier, etc. of the signal received by the radio signal processing unit 1202.

The radio signal control unit 1212 controls the receiving operation in the certain radio resource range described above at the radio signal processing unit 1202. For example, the radio signal control unit 1212 controls the radio signal processing unit 1202 so as to demodulate only the frequency component of the first radio resource range or the second radio resource range.

The radio signal control unit 1212 controls the transmission process at the radio signal processing unit 1202, under the control of the terminal function control unit 1207. For example, the radio signal control unit 1212 controls the frequency, the electric power, etc. of the signal transmitted by the radio signal processing unit 1202.

When the terminal 1200 is applied to the first terminal 101, a receiving apparatus that receives the pieces of the assignment information from the base station 110 may be implemented by, for example, the antenna 1201, the radio signal processing unit 1202, the reception signal decomposing unit 1203, and the control signal analyzing unit 1206. A communicating apparatus that receives a signal from the second terminal 102 may be implemented by, for example, the antenna 1201, the radio signal processing unit 1202, the reception signal decomposing unit 1203, the user reception data analyzing unit 1204, and the control signal analyzing unit 1206. A communicating apparatus that transmits a signal to the second terminal 102 may be implemented by, for example, the antenna 1201, the radio signal processing unit 1202, the data signal generating unit 1209, the control information generating unit 1210, and the transmission signal creating unit 1211.

When the terminal 1200 is applied to the second terminal 102, a receiving apparatus that receives the broadcast information from the base station may be implemented by, for example, the antenna 1201, the radio signal processing unit 1202, the reception signal decomposing unit 1203, and the broadcast information analyzing unit 1205. A communicating apparatus that transmits a signal to the first terminal 101 may be implemented by, for example, the antenna 1201, the radio signal processing unit 1202, the data signal generating unit 1209, the control information generating unit 1210, and the transmission signal creating unit 1211.

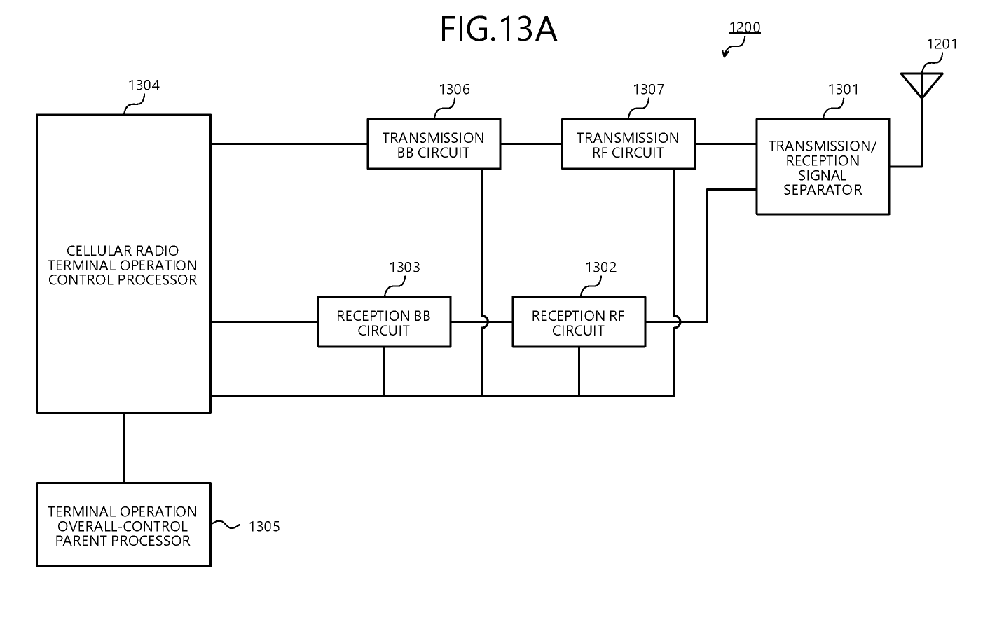

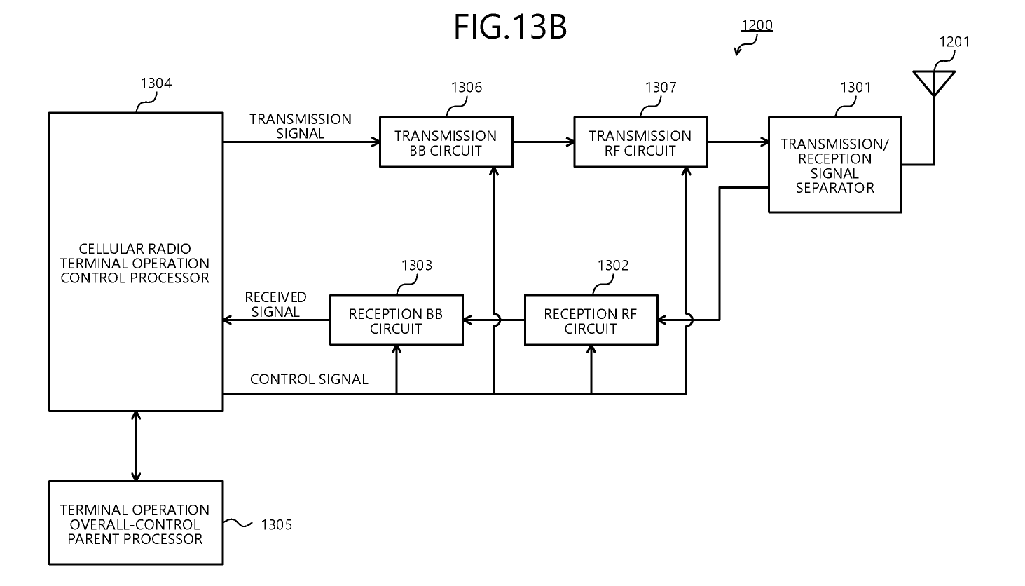

FIG. 13A is a diagram of an example of a hardware configuration of the terminal. FIG. 13B is a diagram of an example of signal flow in the hardware configuration of the terminal depicted in FIG. 13A. In FIGS. 13A and 13B, portions identical to those depicted in FIGS. 12A and 12B are denoted by the same reference numerals used in FIGS. 12A and 12B and will not be described. For example, as depicted in FIGS. 13A and 13B, the terminal 1200 depicted in FIGS. 12A and 12B includes the antenna 1201, a transmission/reception signal separator 1301, a reception RF circuit 1302, a reception BB circuit 1303, and a cellular radio terminal operation control processor 1304. The terminal 1200 also includes a terminal operation overall-control parent processor 1305, a transmission BB circuit 1306, and a transmission RF circuit 1307.

The transmission/reception signal separator 1301 outputs1 to the reception RF circuit 1302, a signal output from the antenna 120 and outputs to the antenna 1201, a signal output from the transmission RF circuit 1307, thereby separating the signals transmitted and received by antenna 1201.

The reception RF circuit 1302 executes a reception process in the RF band for the signal output from the transmission/reception signal separator 1301 and outputs the signal subjected to the reception process in the RF band to the reception BB circuit 1303. The reception BB circuit 1303 executes a reception process in the BB for the signal output from the transmission/reception signal separator 1301 and outputs a signal (reception signal) subjected to the reception processing in the BB to the cellular radio terminal operation control processor 1304.

The cellular radio terminal operation control processor 1304 is a processor that manages the control of communication by the terminal 1200. For example, the cellular radio terminal operation control processor 1304 transmits control signals to control each of the reception RF circuit 1302, the reception BB circuit 1303, the transmission BB circuit 1306, and the transmission RF circuit 1307.

The cellular radio terminal operation control processor 1304 executes a process based on the reception data output from the reception BB circuit 1303. The cellular radio terminal operation control processor 1304 transmits to the transmission BB circuit 1306, a signal (transmission signal) to be transmitted by the terminal 1200.

The terminal operation overall-control parent processor 1305 is a processor that executes a process of the higher layer (e.g., application layer) controlling the cellular radio terminal operation control processor 1304. The cellular radio terminal operation control processor 1304 and the terminal operation overall-control parent processor 1305 may be implemented by, for example, a processor such as a CPU and a DSP.

The transmission BB circuit 1306 executes a transmission process in the BB for the signal output from the cellular radio terminal operation control processor 1304 and outputs the signal subjected to the transmission process in the BB to the transmission RF circuit 1307. The transmission RF circuit 1307 executes a transmission process in the RF band for the signal output from the transmission BB circuit 1306 and outputs the signal subjected to the transmission process in the RF band to the transmission/reception signal separator 1301.

The radio signal processing unit 1202 depicted in FIGS. 12A and 12B may be implemented by, for example, the reception RF circuit 1302, the reception BB circuit 1303, the transmission BB circuit 1306, and the transmission RF circuit 1307. The reception signal decomposing unit 1203, the user reception data analyzing unit 1204, the broadcast information analyzing unit 1205, the control signal analyzing unit 1206, and the terminal function control unit 1207 depicted in FIGS. 12A and 12B may be implemented by the cellular radio terminal operation control processor 1304, for example.

The terminal control higher program executing unit 1208, the data signal generating unit 1209, and the control information generating unit 1210 depicted in FIGS. 12A and 12B may be implemented by the cellular radio terminal operation control processor 1304, for example. The transmission signal generating unit 1211 and the radio signal control unit 1212 depicted in FIGS. 12A and 12B may be implemented by the cellular radio terminal operation control processor 1304, for example.

As described above, according to the embodiment, the first radio resource range and the second radio resource range are configured in the terminal-to-terminal communication between the first terminal 101 and the second terminal 102. The radio resources only in the first radio resource range may be assigned to the terminal-to-terminal communication in the first case, and the radio resources in the first radio resource range and the second radio resource range may be assigned to the terminal-to-terminal communication in the second case.

As a result, in the first case, the radio resources may be specified among those in the limited first range. Specifying the radio resources of those in the first and second ranges may be limited to the second case. Therefore, in a situation where both the first case and the second case occur, the signal notifying the first terminal 101 of the assignment result may be reduced in information amount as compared to a configuration in which radio resources are always assigned among those in the radio resource range having an amount corresponding to the sum of the first radio resource range and the second radio resource range, for example.

For example, conventionally, in a cellular wireless communications system, a region supplied with a communication service is divided into a large number of sections (cells) and a base station is disposed in each cell. A user terminal communicates with the base station of the cell to which the user terminal belongs. Each base station disposed for each section is connected to a core network of the cellular wireless communications system and the core network is connected to the Internet or a core network of a cellular wireless communications system managed by another cellular communication provider.

Although direct communication is performed with the base station of the cellular wireless communications system, the terminal may communicate through the core network with another terminal communicating with the Internet or another base station, or another terminal having a contract with another cellular communication provider. The communication between a terminal and a base station in the cellular wireless communications system is performed, for example, by the following procedure.

First, the terminal receives a synchronization signal constantly transmitted by the base station and acquires the timing of the radio frame transmitted by the base station. The terminal receives broadcast information transmitted by the base station and acquires information of configuration parameters used in the cellular wireless communications system.

The terminal then transmits a connection request signal to the base station. The base station receiving the connection request signal from the terminal ensures radio resources for information exchange required for establishing a connected state, such as terminal authentication, location registration, and issuance of a terminal identification code, and the base station and the terminal exchange information by using the radio resources to establish the connected state.

When the data to be transmitted is generated, the terminal transmits an uplink band assignment request signal to the base station. The base station assigns uplink radio resources to the terminal and the terminal uses the radio resources to send data to the base station.

The terminal continuously receives a downlink control signal from the base station and, when detecting information of radio resources for sending downlink data addressed to the terminal, the terminal performs a downlink data receiving operation with the radio resources to receive the data sent from the base station.

These procedures for the cellular wireless communications system to perform communication between the terminal and the base station are determined in detail in 3rd Generation Partnership Project (3GPP) etc.

However, direct communication between terminals is not assumed in these procedures. For example, when the first terminal attempts to communicate with the second terminal, the first terminal first communicates with the base station to which the first terminal belongs and is linked through the core network to the base station to which the second terminal belongs and then is connected to the second terminal. Even if the first terminal and the second terminal belong to the same base station, the function of connecting the two terminals in the base station does not exist, so that after connection is once made through the core network, communication is performed through the same base station again in general.

If the first terminal and the second terminal have contracts with different cellular communication providers, the connection is made sequentially through the core network of the contracted cellular communication provider of the first terminal and the core network of the contracted cellular communication provider of the second terminal.

In recent years, studies have been conducted on terminal-to-terminal communication allowing terminals in a cellular wireless communications system to directly communicate with each other without communicating through a base station or a core network. This terminal-to-terminal communication makes it possible to ensure communication between terminals even when the base station and the core network are temporarily unavailable due to a disaster, etc. This terminal-to-terminal communication may reduce the processing loads of the base station and the core network increased because terminals such as vending machines and game machines must communicate through the base station and the core network despite being capable of direct communication.

Additionally, if neighboring terminals can perform direct communication with smaller transmission power than that for communications with respective base stations, the power used by terminals for communication may be reduced. In this case, even when terminals in the cellular wireless communications system communicate with each other, the control according to the case of communication with the base station is required.

First, the terminals must acquire information of radio resources used for direct communication. Without this information, the terminals cannot determine when and where to transmit as well as when and where to receive. This information is given as control information from the base station in the usual cellular wireless communications system in which a communications partner of a terminal is always a base station.

Second, unless the radio resources are basically managed by the base station, a signal transmitted by the terminal for terminal-to-terminal direct communication interferes with communication between the base station and the terminal performed according to a conventional technique, or conversely, the terminal-to-terminal communication is interfered with by the conventional base-station terminal-to-terminal communication.

In 3GPP RAN WG1 (e.g., R1-140771), considerations are given to a method of notifying terminals performing terminal-to-terminal communication of information of radio resources used for data communication between terminals by using a radio resource called a schedule assignment pool (SA pool).

When a request for radio resources used in terminal-to-terminal data communication is made from a terminal, the base station gives notification of the assigned radio resources by using the radio resource in this SA pool. It is considered that information of the radio resource used for the SA pool itself is supplied as broadcast information from the base station or is preset in the terminal.

The terminal performs a receiving operation in the radio resources in the SA pool and acquires the information of radio resources used for terminal-to-terminal data communication so as to perform the terminal-to-terminal data communication. If terminal-to-terminal communication is not performed, the receiving operation may be stopped in radio resources other than the SA pool, so that power consumption may be reduced.

If the base station can manage radio resources, desirably, the base station notifies terminals of radio resources usable for terminal-to-terminal communication and the terminals performing terminal-to-terminal communication use these radio resource to perform the terminal-to-terminal communication. This enables suppression of mutual interference between terminal-to-terminal communication and communication of a terminal and a base station with each other as well as interference between two or more different terminal-to-terminal communications.

In this case, the information concerning radio resources used for terminal-to-terminal communication is reported from the base station to the terminals performing terminal-to-terminal communication. The radio resource information is specified by a combination of a location on the time axis and a location on the frequency axis on the radio frame, for example. If a radio resource assignment unit exists in the radio frame made up of N symbols on the time axis and M blocks on the frequency axis, specification must be made among N×M locations.

One terminal performing terminal-to-terminal communication and making a request for radio resources to the base station may be notified of the information of permitted radio resources in response. On the other hand, the method of notifying the other terminal of the radio resource information may be a method in which the base station also notifies the other terminal or a method in which the terminal acquiring the radio resource information from the base station notifies the other terminal through the terminal-to-terminal communication.

In either method, an efficient notification method is desirable. If the method of transmitting the radio resource information is configured such that notification can be made of a wireless resource located at any of N×M locations on the radio frame, flexibility can be ensured in terms of the frame configuration; however, the amount of information required for the notification may increase.

In this regard, according to the embodiment described above, if the amount of radio resources required for terminal-to-terminal communication is small, the radio resources in the first radio resource range alone may be assigned. If the amount of resources required for terminal-to-terminal communication is large, the radio resources in the first and second radio resource ranges may be assigned. As a result, if the amount of radio resources required for terminal-to-terminal communication is small, radio resources may be specified among those in the limited first range. Radio resources may be specified among those in the first and second ranges only when a large amount of radio resources is required for terminal-to-terminal communication. Therefore, the amount of information of a signal notifying a terminal of assigned resources may be reduced.

As described above, according to the wireless communications method, the wireless communications system, the base station, and the terminal, a reduction of the amount of information of the control signal for notification of the radio resources can be achieved.

However, in the conventional technique described above, setting a large amount of radio resources assignable to terminal-to-terminal communication may result in an increased amount of information of control signals notifying a terminal of radio resources assigned to the terminal-to-terminal communication.

According to one aspect of the present invention, an effect is achieved in that the amount of information of control signals for notification of radio resources may be reduced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wireless communications method comprising:
transmitting, by a base station, broadcast information broadcasting a first range of radio resources, wherein
in a first case,
the base station transmits to the first terminal, first assignment information that indicates radio resources in the first range assigned to terminal-to-terminal communication between a first terminal and a second terminal,
the first terminal transmits a signal to the second terminal by using the radio resources indicated by the first assignment information transmitted by the base station, and
the second terminal receives the signal from the first terminal based on the broadcast information transmitted by the base station,
in a second case different from the first case,
the base station transmits to the first terminal, second assignment information that indicates the radio resources in the first range and radio resources in a second range different from the first range and assigned to the terminal-to-terminal communication,
the first terminal transmits control information that indicates the radio resources in the second range indicated by the second assignment information to the second terminal, the first terminal transmitting the control information by using the radio resources in the first range indicated by the second assignment information transmitted by the base station, and
the second terminal receives the control information from the first terminal, based on the broadcast information transmitted by the base station and using the radio resources in the second range, performs at least one of reception of a signal from the first terminal and transmission of a signal to the first terminal, based on the received control information.

2. The wireless communications method according to claim 1, wherein
the first case is a case where an amount of radio resources to be assigned to the terminal-to-terminal communication is equal to or smaller than a predetermined amount, and
the second case is a case where the amount of radio resources to be assigned to the terminal-to-terminal communication is greater than the predetermined amount.

3. The wireless communications method according to claim 1, wherein
the first assignment information includes information indicating that the first assignment information is information that indicates radio resources assigned by the base station to the terminal-to-terminal communication.

4. The wireless communications method according to claim 1, wherein
the first range is a portion of a radio resource range assigned to a cell of the base station.

5. The wireless communications method according to claim 1, wherein
the second range is a portion or a whole of a radio resource range assigned to a cell of the base station and is a range wider than the first range.

6. The wireless communications method according to claim 1, wherein
the first assignment information is information that indicates radio resources in the first range assigned by the base station to the terminal-to-terminal communication in terms of relative positions in the first range, and
in the first case, the first terminal identifies based on the broadcast information and the first assignment information, the radio resources in the first range assigned by the base station to the terminal-to-terminal communication.

7. The wireless communications method according to claim 1, wherein
the base station transmits broadcast information broadcasting the second range,
the second assignment information is information that indicates radio resources in the second range assigned by the base station to the terminal-to-terminal communication in terms of relative positions in the second range, and
in the second case, the first terminal identifies based on the broadcast information broadcasting the second range and the second assignment information, the radio resources in the second range assigned by the base station to the terminal-to-terminal communication.

8. The wireless communications method according to claim 7, wherein
the control information is information that indicates radio resources in the second range in terms of relative positions in the second range, and
in the second case, the second terminal identifies the radio resources in the second range, based on the broadcast information broadcasting the second range and the control information.

9. The wireless communications method according to claim 1, wherein
the second range is a range identifiable based on the first range, and
the first terminal and the second terminal identify the second range based on the first range indicated by the broadcast information broadcasting the first range.

10. The wireless communications method according to claim 1, wherein
the control information includes information indicating that the control information is information that indicates radio resources in the second range.

11. The wireless communications method according to claim 1, wherein
in the first case,
the first terminal uses a first resource of the radio resources in the first range to transmit to the second terminal, the signal that indicates a second resource different from the first resource of the radio resources in the first range, and
the second terminal uses the second resource indicated by the received signal to transmit a signal to the first terminal.

12. The wireless communications method according to claim 1, wherein
in the second case,
the first terminal uses the radio resources in the first range to transmit to the second terminal, control information that indicates a first resource and a second resource different from the first resource among the radio resources in the second range, the first terminal using the first resource to transmit a signal to the second terminal, and
the second terminal receives the signal from the first terminal based on the first resource indicated by the received control information and uses the second resource indicated by the received control information to transmit a signal to the first terminal.

13. A terminal configured to communicate with a base station that transmits broadcast information broadcasting a first range of radio resources, the terminal comprising:
a receiving apparatus configured to receive from the base station, first assignment information that indicates radio resources in the first range assigned by the base station to terminal-to-terminal communication between the terminal and a second terminal in a first case, the receiving apparatus receiving from the base station second assignment information that indicates the radio resources in the first range and radio resources in a second range different from the first range assigned by the base station to the terminal-to-terminal communication in a second case different from the first case; and
a communicating apparatus configured to, in the first case, transmit a signal to the second terminal by using the radio resources indicated by the first assignment information received by the receiving apparatus, the communicating apparatus, in the second case, transmitting to the second terminal, control information that indicates the radio resources in the second range indicated by the second assignment information, the communicating apparatus transmitting the control information by using the radio resources in the first range indicated by the second assignment information received by the receiving apparatus and performing at least one of transmission of a signal to the second terminal and reception of a signal from the second terminal, by using the radio resources in the second range.

14. A terminal comprising:
a receiving apparatus configured to receive broadcast information broadcasting a first range of radio resources, the broadcast information being received from a base station transmitting the broadcast information; and
a communicating apparatus configured to receive in a first case and based on the broadcast information received by the receiving apparatus, a signal transmitted by a second terminal, the communicating apparatus receiving the signal by using radio resources in the first range assigned by the base station to terminal-to-terminal communication between the terminal and the second terminal, wherein
in a second case different from the first case, the communicating apparatus receives based on the broadcast information, control information transmitted by the second terminal by using the radio resources in the first range among the radio resources in the first range and radio resources in a second range different from the first range assigned by the base station to the terminal-to-terminal communication, the control information indicating the radio resources in the second range, and
the communicating apparatus performs based on the received control information, at least one of reception of a signal from the second terminal and transmission of a signal to the second terminal, by using the radio resources in the second range.
